(19) United States
(12) Patent Application Publication
(10) Pub. No.: US 2021/0276649 A1
(43) Pub. Date: Sep. 9, 2021

(54) VEHICLE LOCK

(71) Applicant: BEIJING QISHENG SCIENCE AND TECHNOLOGY CO., LTD., Beijing (CN)

(72) Inventors: Fengbang WANG, Beijing (CN); Weidong ZHANG, Beijing (CN)

(73) Assignee: BEIJING QISHENG SCIENCE AND TECHNOLOGY CO., LTD., Beijing (CN)

(21) Appl. No.: 17/325,182

(22) Filed: May 19, 2021

Related U.S. Application Data
(63) Continuation of application No. PCT/CN2019/119440, filed on Nov. 19, 2019.

(30) Foreign Application Priority Data
Nov. 19, 2018 (CN) 201811379056.7
Nov. 19, 2018 (CN) 201811379060.3
Nov. 19, 2018 (CN) 201811379066.0

(51) Int. Cl. B62H 5/14

(52) U.S. Cl. CPC B62H 5/148

(57) ABSTRACT

The present disclosure provides a lock for locking a vehicle with a wheel comprising spokes. The lock may include a lock body and a locking member. The lock body may include a lock pin, and the locking member may include at least one locking hole. The vehicle may be locked by inserting the lock pin into the at least one locking hole without crossing any of the spokes from a first side to a second side of the wheel.

### CROSS-REFERENCE TO RELATED APPLICATION

This application is a continuation of International Patent Application No. PCT/CN2019/119440, filed on Nov. 19, 2019, which claims priority of Chinese Patent Application No. 201811379056.7, filed on Nov. 19, 2018, Chinese Patent Application No. 201811379066.0, filed on Nov. 19, 2018, and Chinese Patent Application No. 201811379060.3, filed on Nov. 19, 2018, the contents of each of which are entirely incorporated herein by reference.

### TECHNICAL FIELD

The present disclosure generally relates to vehicle technology, and more particularly, to a lock for locking a vehicle.

### BACKGROUND

A horseshoe lock is commonly used to lock a vehicle. Normally, a lock pin of the horseshoe may cross spokes of the vehicle from one side of to the other side of a wheel of the vehicle, so as to restrict the movement of the spokes and lock the vehicle. After the bicycle is locked by the horseshoe lock, the wheel may still be rotatable and the lock pin of the horseshoe lock may be moveable between the two spokes adjacent to the lock pin. The lock pin may collide with the spokes if the bicycle is moved, which may cause deformation and damage to the spokes and affect the service life of the vehicle. Thus, it may be desirable to provide a more effective vehicle lock.

### SUMMARY

One aspect of the disclosure provides a lock for locking a vehicle. The vehicle may include a frame and a wheel. The lock may include a lock body and a locking member. The lock body may include a lock pin. The locking member may include at least one locking hole. One of the lock body or the locking member may be mounted on the frame, and the other one of the lock body or the locking member may be mounted on the wheel and rotate with the wheel. The vehicle may be locked by inserting the lock pin into the at least one locking hole.

In some embodiments, the locking member may include a ring body. An axis of the ring body may be parallel to an axis of the wheel, and the at least one locking hole may be located on the ring body.

In some embodiments, an axis of the at least one locking hole may be parallel to the axis of the ring body, and the lock pin may be inserted into the at least one locking hole along an axial direction of the ring body.

In some embodiments, the ring body and the lock body may be mounted on a rotation shaft of the wheel, and the lock body may be spaced apart from a front surface of the ring body by a distance.

In some embodiments, an axis of the at least one locking hole may be parallel with a radial direction of the ring body, and the lock pin may be inserted into the at least one locking hole along the radial direction of the ring body.

In some embodiments, the ring body may be mounted on a rotation shaft of the wheel, and the lock body may be mounted on the frame and located on an outside circumference of the ring body.

In some embodiments, the ring body may include a connection base and a locking ring. The locking ring may include the at least one locking hole and be mounted on one side of the connection base.

In some embodiments, the connection base may be a circular plate.

In some embodiments, a diameter of the connection base may be equal to an outer diameter of the locking ring.

In some embodiments, the locking member may include a disc body. An axis of the disc body may be parallel to an axis of the wheel, and the at least one locking hole may be located on the disc body.

In some embodiments, an axis of the at least one locking hole may be parallel to the axis of the disc body, and the lock pin may be inserted into the at least one locking hole along an axial direction of the disc body.

In some embodiments, the disc body and the lock body may be mounted on a rotation shaft of the wheel, and the lock body may be spaced apart from a front surface of the disc body by a distance.

In some embodiments, the wheel may include a wheel hub, and the disc body may be located at one end of a shaft hole of an inner ring of the wheel hub.

In some embodiments, the disc body may include a mounting hole, and the mounting hole may be coaxial with the disc body.

In some embodiments, the disc body may include a connection shaft, and the connection shaft may be coaxial with the disc body.

In some embodiments, the connection shaft may include a connection hole, and the connection hole may be coaxial with the connection shaft.

In some embodiments, the connection hole may be a straight hole.

In some embodiments, the at least one locking hole may include a plurality of locking holes, and the plurality of locking holes may be arranged uniformly around the axis of the locking member.

In some embodiments, the at least one locking hole may be a through hole.

In some embodiments, the at least one locking hole may have an opening at the side surface of the at least one locking hole.

In some embodiments, a side of the at least one locking hole facing the lock pin may have a chamfer.

In some embodiments, the chamfer may be a circular chamfer.

In some embodiments, the vehicle may further include a wheel sensor mounted on the locking member. The wheel sensor may be configured to detect a rotational state of the wheel.

In some embodiments, the wheel sensor may include at least one of a distance sensor or a pressure sensor.

Another aspect of the disclosure provides a lock body. The lock body may include a lock pin, a transmission mechanism, and a driving member. The transmission mechanism may be mechanically connected to the lock pin. The driving member may be mechanically connected to the transmission mechanism and configured to drive the movement of the lock pin via the transmission mechanism.

In some embodiments, the lock body may further include a housing. The driving member and the transmission mechanism may be located within the housing. The housing may include a pin hole matching the lock pin.

In some embodiments, the transmission mechanism may include a transmission wheel, a first linkage member, and a protrusion. A first side of the transmission wheel may be mechanically connected to the driving member. The first linkage member may be mechanically connected to the lock pin. The protrusion may abut against at least a portion of the first linkage member and be mounted on a second side of the transmission wheel. The second side of the transmission wheel may be opposite to the first side of the transmission wheel. Driven by the driving member, the protrusion may be configured to retract the lock pin from a locking hole.

In some embodiments, the first linkage member and the lock pin may form an integral part.

In some embodiments, the first linkage member may include a stopping member, and one side of the stopping member may abut against the protrusion for restricting a rotation of the transmission wheel.

In some embodiments, the transmission mechanism may include a second linkage member and a transmission cam. The second linkage member may be fixedly mounted on the lock pin. The transmission cam may be mounted on the driving member. A sidewall of the transmission cam may abut against at least a portion of the second linkage member. Driven by the driving member, the transmission cam may be configured to retract the lock pin from a locking hole.

In some embodiments, the lock body may further include a reset device. The reset device may be mounted on the lock pin and configured to retract the lock pin from a locking hole or insert the lock pin into the locking hole.

In some embodiments, the reset device may include a first compression spring. A first end of the first compression spring may be fixedly mounted on the housing, and a second end of the first compression spring opposite to the first end of the first compression spring may abut against the lock pin.

In some embodiments, the lock pin may include an abutting step.

The first compression spring may be sleeved on the lock pin, and the second end of the first compression spring may abut against the abutting step.

In some embodiments, the lock body may further include a seal ring. The seal ring may be located at the first end of the first compression spring.

In some embodiments, the seal ring may be a silicone gasket.

In some embodiments, the lock body may further include a metal gasket. The metal gasket may be located between the first end of the first compression spring and the seal ring.

In some embodiments, the reset device may include a first tension spring. The first tension spring may be configured to insert the lock pin into the locking hole. A first end of the first tension spring may be fixedly connected to the lock pin, and a second end of the first tension spring may be fixedly mounted on the housing.

In some embodiments, the lock body may further include a first detection switch. The first detection switch may be mechanically connected to the transmission mechanism and configured to detect whether the lock pin inserted into a locking hole.

In some embodiments, the lock body may further include a second detection switch. The second detection switch may be mechanically connected to the transmission mechanism and configured to detect whether the lock pin is retracted from a locking hole.

In some embodiments, a wheel sensor may be mounted on the housing and configured to detect a rotational state of a wheel.

In some embodiments, the lock body may further include a mechanical locking mechanism. The mechanical locking mechanism may be configured to lock the first linkage member after the lock pin is retracted.

In some embodiments, the mechanical locking mechanism may include a rotation lever, a locking block, and a rotation shaft. The locking block may be located at a first side at a first end of the rotation lever. The rotation lever may be mechanically connected to the rotation shaft and configured to rotate around the rotation shaft to drive the locking block to abut against the first linkage member.

In some embodiments, the mechanical locking mechanism may further include an elastic device. The elastic device may be mechanically connected to the rotation lever and configured to drive the locking block to rotate toward the first linkage member.

In some embodiments, the elastic device may include a second compression spring. A first end of the second compression spring may be fixed on a housing of the lock body, and a second end of the second compression spring may abut against the first side at a second end of the rotation lever. The locking block and the second end of the second compression spring may be located at two sides of the rotation shaft.

In some embodiments, the elastic device may include a third compression spring. A first end of the third compression spring may be fixed on a housing of the lock body, and a second end of the third compression spring may abut against a second side at the first end of the rotation lever. The second side at the first end of the rotation lever may be opposite to the first side at the first end of the rotation lever, and the locking block and the second end of the third compression spring may be located on a same side of the rotation shaft.

In some embodiments, the elastic device may include a second tension spring. A first end of the second tension spring may be fixedly mounted on a housing, and a second end of the second tension spring may be mechanically connected to the rotation lever. A connection point between the second tension spring and the rotation lever may be located at the first side of the rotation lever, and the locking block and the second tension spring may be located on a same side of the rotation shaft.

In some embodiments, the elastic device may include a third tension spring. A first end of the third tension spring may be fixed on the housing, and a second end of the third tension spring may be mechanically connected to the rotation lever. A connection point between the third tension spring and the rotation lever may be located at a second side of the rotation lever, and the locking block and the third tension spring may be located at two sides of the rotation shaft.

In some embodiments, the elastic device may include a first torsion spring. A central axis of the first torsion spring and the locking block may be located at a same side of the rotation shaft. A protruding end of the first torsion spring may abut against a second side at the first end of the rotation lever. The second side at the first end of the rotation lever may be opposite the first side at the first end of the rotation lever.

In some embodiments, the elastic device may include a second torsion spring. A central axis of the second torsion spring and the locking block may be located at two sides of the rotation shaft. A protruding end of the second torsion spring may abut against the first side at a second end of the rotation lever. The second end of the rotation lever may be opposite to the first end of the rotation lever.

In some embodiments, a side of the locking block away from the rotation shaft may include a sliding slope. The sliding slope may have a first end adjacent to the rotation lever and a second end away from the rotation lever. A distance between the first end and the rotation shaft may be longer than a distance between the second end and the rotation shaft.

In some embodiments, the driving member may include a driving motor. In some embodiments, an end of the housing may have a curved surface that matches a locking member.

In some embodiments, the housing may include a main housing and a housing cover. The housing cover may be mechanically connected to the main housing to form an enclosed cavity for accommodating the driving member and the transmission mechanism.

In some embodiments, the main housing may include a first mounting member for mounting a first detection switch. The first detection switch may be configured to detect whether the lock pin is inserted into a locking hole.

In some embodiments, the first mounting member may include a first mounting hole.

In some embodiments, the main housing may include a second mounting member for mounting the lock pin.

In some embodiments, the second mounting member may include a second mounting hole for mounting the lock pin.

In some embodiments, the second mounting hole may include a sliding section and a reset section. The lock pin may be inserted into the second mounting hole through the sliding section, and a reset device may be mounted in the reset section.

In some embodiments, the diameter of the reset section may be greater than the diameter of the sliding section.

Yet another aspect of the disclosure provides a lock body. The lock body may include a lock pin, an electromagnet, and a magnetic core. The electromagnet may include a sliding hole. The magnetic core may be slidably mounted within the sliding hole and mechanically connected to the lock pin. Under the action of the electromagnet, the magnetic core may be configured to drive the lock pin to slide along the sliding hole.

In some embodiments, the lock body may further include a detection switch. The detection switch may be configured to detect a position of the magnetic core.

In some embodiments, the detection switch may have a U-shape.

In some embodiments, the detection switch may include at least one of a distance sensor or a pressure sensor.

In some embodiments, the lock body may further include a housing for accommodating the electromagnet and the magnetic core.

In some embodiments, a wheel sensor may be mounted on the housing and configured to detect a rotational state of a wheel.

In some embodiments, the housing may include a left housing and a right housing. The left housing and the right housing may be detachably connected to each other.

In some embodiments, the right housing may include a mounting hole.

In some embodiments, the lock body may further include a reset device. The reset device may be mounted on the lock pin and configured to drive the lock pin to move away from the electromagnet.

In some embodiments, the reset device may include a compression spring. A first end of the compression spring may be fixedly mounted on the housing or the magnetic core, and a second end of the compression spring may abut against the lock pin.

In some embodiments, the lock pin may include an abutting step.

The compression spring may be sleeved on the lock pin, and the second end of the compression spring may abut against the abutting step.

In some embodiments, the lock body may further include a seal ring. The seal ring may be located at the first end of the compression spring.

In some embodiments, the seal ring may be a silicone gasket.

In some embodiments, the lock body may further include a metal gasket. The metal gasket may be located between the first end of the compression spring and the seal ring.

In some embodiments, the reset device may include a tension spring. The tension spring may be configured to insert the lock pin into the locking hole. A first end of the tension spring may be fixedly connected to the lock pin, and a second end of the tension spring may be fixed on the housing or the magnetic core.

In some embodiments, the magnetic core may include a through hole, and the lock pin may be inserted into the through hole.

In some embodiments, the through hole may include a sliding section and a reset section. The lock pin may be inserted into the through hole through the sliding section, and the reset device may be mounted within the reset section.

In some embodiments, the diameter of the reset section may be greater than the diameter of the sliding section.

In some embodiments, the through hole may be a threaded hole, and an end of the lock pin may have an external thread matching the threaded hole.

In some embodiments, the through hole may be a straight hole. The lock pin may include a first slot, and a first circlip may be mounted in the first slot for preventing the lock pin from sliding out from the through hole.

In some embodiments, a first end of the magnetic core may include a stopping member. An outer wall of a second end of the magnetic core may include a second slot, and a second circlip may be mounted in the second slot for preventing the magnetic core from sliding out from the electromagnet.

Yet another aspect of the disclosure provides a lock for locking a vehicle. The vehicle may include a wheel. The wheel may include spokes. The lock may include a lock body and a locking member. The lock body may include a lock pin. The locking member may include at least one locking hole. The vehicle may be locked by inserting the lock pin into the at least one locking hole without crossing any of the spokes from a first side to a second side of the wheel.

In some embodiments, the vehicle may further include a frame. One of the lock body or the locking member may be mounted on the frame, and the other one of the lock body or the locking member may be mounted on the wheel and rotate with the wheel.

In some embodiments, the locking member may include a ring body. An axis of the ring body may be parallel to an axis of the wheel, and the at least one locking hole may be located on the ring body.

In some embodiments, an axis of the at least one locking hole may be parallel to an axial direction of the ring body, and the lock pin may be inserted into the at least one locking hole along the axial direction of the ring body, or the axis of the at least one locking hole may be parallel with a radial direction of the ring body, and the lock pin may be inserted into the at least one locking hole along the radial direction of the ring body.

In some embodiments, the locking member may include a disc body. An axis of the disc body may be parallel to an axis of the wheel, and the at least one locking hole may be located on the disc body.

In some embodiments, an axis of the at least one locking hole may be parallel to an axial direction of the disc body, and the lock pin may be inserted into the at least one locking hole along the axial direction of the disc body.

In some embodiments, the lock body may further include a transmission mechanism and a driving member. The transmission mechanism may be mechanically connected to the lock pin. The driving member may be mechanically connected to the transmission mechanism and configured to drive a movement of the lock pin via the transmission mechanism.

In some embodiments, the transmission mechanism may include a transmission wheel, a first linkage member, and a protrusion. A first side of the transmission wheel may be mechanically connected to the driving member. The first linkage member may be mechanically connected to the lock pin. The protrusion may abut against at least a portion of the first linkage member and be mounted on a second side of the transmission wheel. The second side of the transmission wheel may be opposite to the first side of the transmission wheel. Driven by the driving member, the protrusion may be configured to retract the lock pin from a locking hole.

In some embodiments, the lock body may further include a mechanical locking mechanism. The mechanical locking mechanism may be configured to lock the first linkage member after the lock pin is retracted. The mechanical locking mechanism may include a rotation lever, a locking block, and a rotation shaft. The locking block may be located at an end of the rotation lever. The rotation lever may be mechanically connected to the rotation shaft and configured to rotate around the rotation shaft to drive the locking block to abut against the first linkage member.

In some embodiments, the mechanical locking mechanism may further include an elastic device. The elastic device may be mechanically connected to the rotation lever and configured to drive the locking block to rotate toward the first linkage member.

In some embodiments, the elastic device may include at least one of a compression spring, a tension spring, or a torsion spring.

In some embodiments, the transmission mechanism may include a second linkage member and a transmission cam. The second linkage member may be fixed with the lock pin. The transmission cam may be mounted on the driving member. A sidewall of the transmission cam may abut against at least a portion of the second linkage member. Driven by the driving member, the transmission cam may be configured to retract the lock pin from the at least one locking hole.

In some embodiments, the lock body may further include an electromagnet and a magnetic core. The electromagnet may include a sliding hole. The magnetic core may be slidably mounted within the sliding hole and mechanically connected to the lock pin. Under the action of the electromagnet, the magnetic core may be configured to drive the lock pin to slide along the sliding hole.

In some embodiments, the magnetic core may include a through hole, and the lock pin may be inserted into the through hole.

In some embodiments, the through hole may be a threaded hole, and an end of the lock pin may have an external thread matching the threaded hole.

In some embodiments, the through hole may be a straight hole. The lock pin may include a first slot, and a first circlip may be mounted in the first slot for preventing the lock pin from sliding out from the through hole.

In some embodiments, a first end of the magnetic core may include a stopping member. An outer wall of a second end of the magnetic core may include a second slot, and a second circlip may be mounted in the second slot for preventing the magnetic core from sliding out from the electromagnet.

In some embodiments, the lock body may further include a reset device. The reset device may be mounted on the lock pin and configured to retract the lock pin from the at least one locking hole or insert the lock pin into the at least one locking hole.

In some embodiments, the lock body may further include a detection switch. The detection switch may be configured to detect a position of the lock pin.

In some embodiments, the vehicle may further include a wheel sensor. The wheel sensor may be configured to detect a rotational state of the wheel.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary vehicle according to some embodiments of the present disclosure;

FIG. 2 is a schematic diagram illustrating a portion of an exemplary vehicle according to some embodiments of the present disclosure;

FIG. 3 is a schematic diagram illustrating a partial enlarged view of an exemplary lock in FIG. 2 according to some embodiments of the present disclosure;

FIG. 4 is a schematic diagram illustrating a partial enlarged view of the lock in FIG. 2 according to some embodiments of the present disclosure;

FIG. 5 is a schematic diagram illustrating a front view of a housing of an exemplary lock body according to some embodiments of the present disclosure;

FIG. 6 is a schematic diagram illustrating a rear view of a housing of an exemplary lock body according to some embodiments of the present disclosure;

FIG. 7 is a schematic diagram illustrating a sectional view of a housing of an exemplary lock body according to some embodiments of the present disclosure;

FIG. 8 is a schematic diagram illustrating a sectional view of an exemplary lock body according to some embodiments of the present disclosure;

FIG. 9 is a schematic diagram illustrating a sectional view of an exemplary magnetic core of a lock body according to some embodiments of the present disclosure;

FIG. 10 is a schematic diagram illustrating a sectional view of an exemplary lock pin of a lock body according to some embodiments of the present disclosure;

FIG. 11 is a schematic diagram illustrating a perspective view of an exemplary lock according to some embodiments of the present disclosure;

FIG. 12 is a schematic diagram illustrating a top view of an exemplary lock according to some embodiments of the present disclosure;

FIG. 13 is a schematic diagram illustrating a partial enlarged view of the lock in FIG. 11 according to some embodiments of the present disclosure;

FIG. 14 is a schematic diagram illustrating a partial enlarged view of the lock in FIG. 11 according to some embodiments of the present disclosure;

FIG. 15 is a schematic diagram illustrating a partial enlarged view of the lock in FIG. 11 according to some embodiments of the present disclosure;

FIG. 16 is a schematic diagram illustrating an exemplary main housing according to some embodiments of the present disclosure;

FIG. 17 is a schematic diagram illustrating a sectional view of an exemplary second mounting hole according to some embodiments of the present disclosure;

FIG. 18 is a schematic diagram illustrating a sectional view of the lock in FIG. 11 according to some embodiments of the present disclosure;

FIG. 19 is a schematic diagram illustrating an enlarged view of a portion of the lock in FIG. 11 according to some embodiments of the present disclosure;

FIG. 20 is a schematic diagram illustrating an exemplary lock according to some embodiments of the present disclosure;

FIG. 21 is a schematic diagram illustrating an enlarged view of a portion of the lock in FIG. 20 according to some embodiments of the present disclosure;

FIG. 22 is a schematic diagram illustrating a first exemplary elastic device according to some embodiments of the present disclosure;

FIG. 23 is a schematic diagram illustrating a second exemplary elastic device according to some embodiments of the present disclosure;

FIG. 24 is a schematic diagram illustrating a third exemplary elastic device according to some embodiments of the present disclosure;

FIG. 25 is a schematic diagram illustrating a fourth exemplary elastic device according to some embodiments of the present disclosure;

FIG. 26 is a schematic diagram illustrating a fifth exemplary elastic device according to some embodiments of the present disclosure;

FIG. 27 is a schematic diagram illustrating a sixth exemplary elastic device according to some embodiments of the present disclosure;

FIG. 28 is a schematic diagram illustrating a front view of an exemplary locking member according to some embodiments of the present disclosure;

FIG. 29 is a schematic diagram illustrating a sectional view of the locking member in FIG. 28 according to some embodiments of the present disclosure;

FIG. 30 is a schematic diagram illustrating another sectional view of the locking member in FIG. 28 according to some embodiments of the present disclosure;

FIG. 31 is a schematic diagram illustrating a front view of an exemplary locking member according to some embodiments of the present disclosure;

FIG. 32 is a schematic diagram illustrating a sectional view of the locking member in FIG. 31 according to some embodiments of the present disclosure;

FIG. 33 is a schematic diagram illustrating a front view of an exemplary locking member according to some embodiments of the present disclosure;

FIG. 34 is a schematic diagram illustrating a sectional view of the locking member in FIG. 33 according to some embodiments of the present disclosure;

FIG. 35 is a schematic diagram illustrating a front view of an exemplary locking member according to some embodiments of the present disclosure; and

FIG. 36 is a schematic diagram illustrating a partial enlarged view of a portion of an exemplary vehicle on which the locking member in FIG. 35 is mounted according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

It will be understood that, although the terms “first,” “second,” “third,” etc., may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention.

Spatial and functional relationships between elements (for example, between layers) are described using various terms, including “connected,” “engaged,” “interfaced,” and “coupled.” Unless explicitly described as being “direct,” when a relationship between first and second elements is described in the present disclosure, that relationship includes a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The present disclosure relates to a lock for locking a vehicle. The vehicle may include a frame and a wheel. The wheel may include a plurality of spokes. The lock may include a lock body and a locking member. The lock body may include a lock pin and the locking member may include at least one locking hole. The vehicle may be locked by inserting the lock pin into the at least one locking hole without crossing any of the spokes from a first side to a second side of the wheel. This may prevent the lock pin from colliding with the spokes and increase the service life of the spokes and the lock pin.

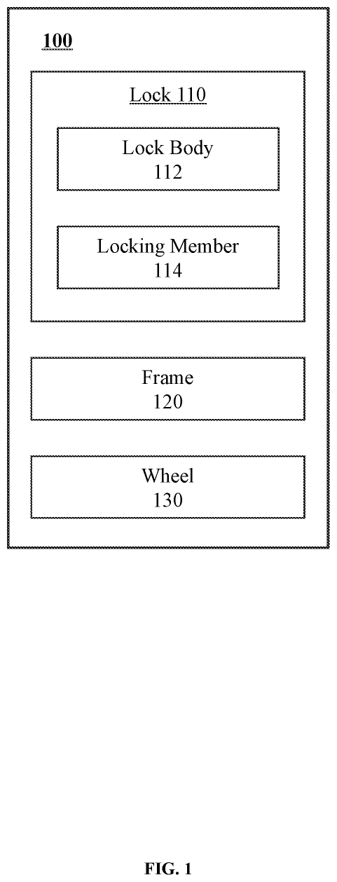

FIG. 1 is a block diagram illustrating an exemplary vehicle 100 according to some embodiments of the present disclosure. As used herein, a vehicle refers to any device for carrying or transporting something. For example, the vehicle may include a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof. The vehicle may be applied in different environments including land, ocean, aerospace, or the like, or any combination thereof.

As illustrated in FIG. 1, the vehicle 100 may include a lock 110, a frame 120, and a wheel 130. The lock 110 may be configured to lock the vehicle 100. In some embodiments, the lock 110 may include a lock body 112 and a locking member 114. The lock body 112 may include a lock pin, and the locking member 114 may include at least one locking hole. The lock pin may be inserted into the at least one locking hole to lock the vehicle 100 or retracted from the at least one locking hole to unlock the vehicle 100. As used herein, “insert into at least one locking hole” refers to insert into one of the at least one locking hole, and “retract from at least one locking hole” refers to retract from one of the at least one locking hole. For brevity, the at least one locking hole may also be referred to as the locking hole. In some embodiments, the wheel 130 may include a plurality of spokes, and the lock pin may be inserted into the at least one locking hole without crossing any of the spokes from a first side to a second side of the wheel 130. This may prevent the lock pin from colliding with the spokes and increase the service life of the spokes and the lock pin.

In some embodiments, the lock 110 (or a portion thereof) may be mounted on any suitable position of the vehicle 100. For example, the lock body 112 may be mounted on the frame 120, and the locking member 114 may be mounted on the wheel 130 (e.g., an inner circumference of a wheel rim, an outer circumference of the spokes, etc.) and rotate with the wheel 130. As another example, the lock body 112 may be mounted on the wheel 130 and rotate with the wheel 130, and the locking member 114 may be mounted on the frame 120. In this way, one of the lock body 112 and the locking member 114 may be rotatable with the wheel 130, and the other one of the lock body 112 and the locking member 114 may remain stationary. The vehicle 100 may be locked when the positions of the lock pin of the lock body 112 and the locking hole of the locking member 114 match each other and the lock pin is inserted into the locking hole.

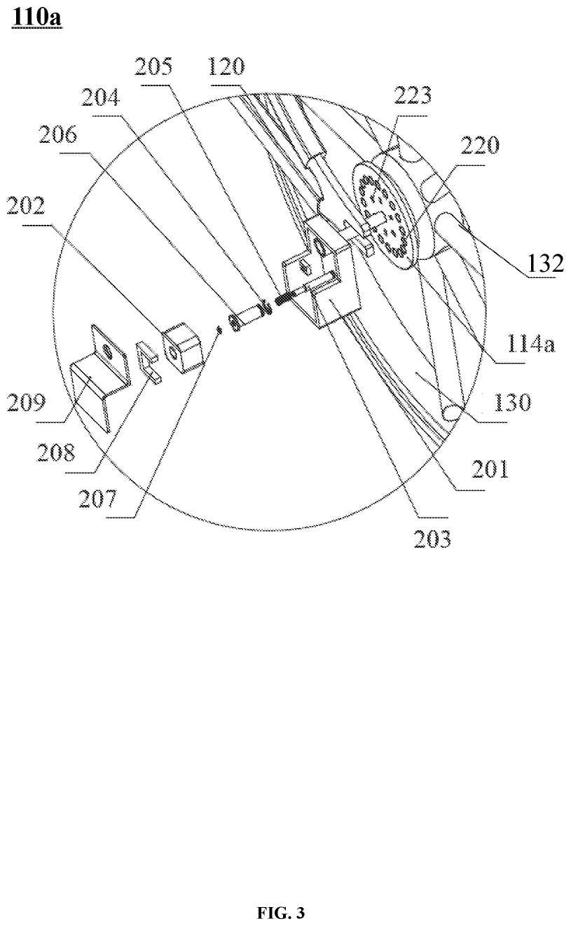

In some embodiments, the lock body 112 may further include a housing, a driving mechanism, a reset device, or the like, or any combination thereof. The housing may form an accommodation space for accommodating and protecting one or more internal components of the lock body 112 (e.g., the lock pin, the reset device, the driving member, etc.). The driving mechanism may be configured to drive the movement of the lock pin. For example, the driving mechanism may include a driving member (e.g., a driving member 1108 as shown in FIG. 14) and a transmission mechanism (e.g., a transmission mechanism 1110 as shown in FIG. 14). The driving member may be mechanically connected to the transmission mechanism, and the transmission mechanism may be mechanically connected to the lock pin. The driving member may be configured to drive the movement of the transmission mechanism, which in turn, may drive the movement of the lock pin. As another example, the driving mechanism may include an electromagnet (e.g., an electromagnet 202 as shown in FIG. 3) and a magnetic core (e.g., a magnetic core 206 as shown in FIG. 3). The magnetic core may be slidably mounted within a sliding hole of the electromagnet and mechanically connected to the lock pin. Under the action of the electromagnet, the magnetic core may move and drive the lock pin to slide along the sliding hole of the electromagnet.

The reset device may be configured to protect the lock pin when the position of the lock pin does not match the position of the at least one locking hole. For example, the driving mechanism (e.g., the driving member or the electromagnet as aforementioned) may stop driving the lock pin if the lock pin reaches a position close to the at least one locking hole. If the position of the lock pin does not match the position of the at least one locking hole, the lock pin may abut against the surface of the locking member 114 due to the reset device without striking the locking member 114. The lock pin or the at least one locking hole may move with the rotation of the wheel 130, and the lock pin may be driven by the reset device and inserted into the at least one locking hole when the positions of the at least one locking hole and the lock pin match each other. In some embodiments, the reset device may include a compression spring (e.g., a compression spring 205), a tension spring, or one or more other elastic structures such as a rubber band.

It should be noted that the above description of the vehicle 100 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the vehicle 100 may include one or more additional components and/or one or more components of the vehicle 100 described above may be omitted. Additionally or alternatively, two or more components of the vehicle 100 may be integrated into a single component. A component of the vehicle 100 may be implemented on two or more sub-components.

For example, the vehicle 100 may further include a wheel sensor configured to detect the rotational state of the wheel 130 so as to prevent the lock pin from being inserted into the at least one locking hole while the wheel 130 is still rotating. The wheel sensor may be mounted on, for example, the lock body 112, the locking member 114, the frame 120, or the wheel 130 of the vehicle 100. The wheel sensor may include a distance sensor, a speed sensor, or any other sensor that may detect the rotational state of the wheel 130.

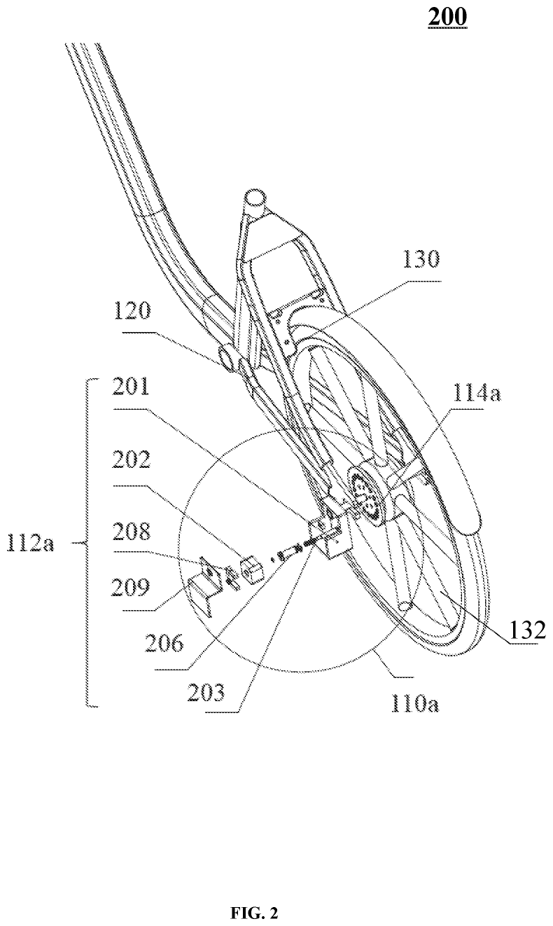

FIG. 2 is a schematic diagram illustrating a portion of an exemplary vehicle 200 according to some embodiments of the present disclosure. The vehicle 200 may be an exemplary embodiment of the vehicle 100 as described in connection with FIG. 1. As shown in FIG. 2, the vehicle 200 may include a frame 120, a wheel 130, and a lock 110a. The lock 110a may be an exemplary embodiment of the lock 110 as described in connection with FIG. 1, which may be configured to lock the vehicle 200. The wheel 130 may include a plurality of spokes 132.

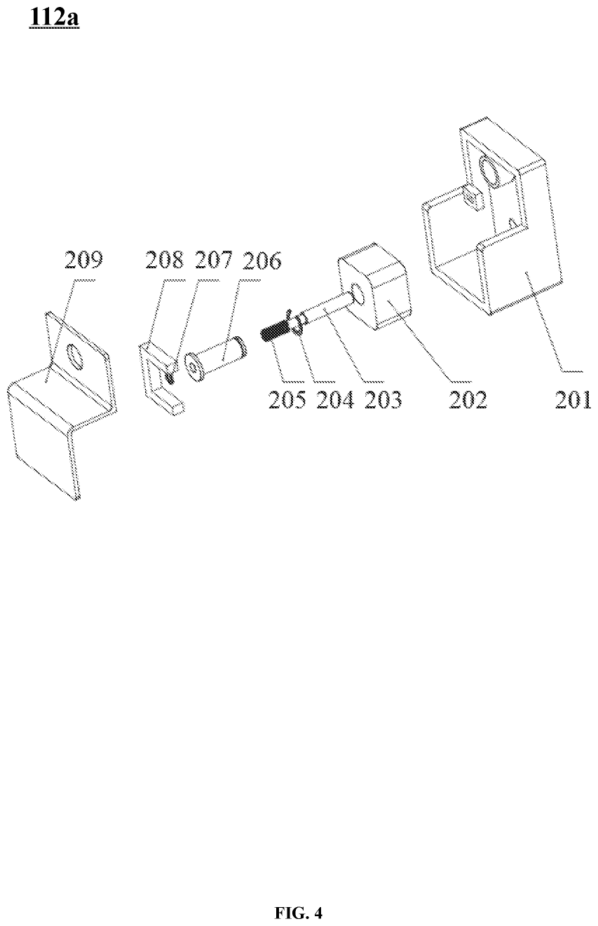

For illustration purposes, partial enlarged views of the lock 110a are illustrated in FIGS. 3 and 4. As shown in FIGS. 2 to 4, the lock 110a may include a lock body 112a and a locking member 114a. The lock body 112a may be mounted on the frame 120, and the locking member 114a may be mounted on the wheel 130 and rotate with the wheel 130. In some alternative embodiments, the lock body 112a may be mounted on the wheel 130 and rotate with the wheel 130, and the locking member 114a may be mounted on the frame 120.

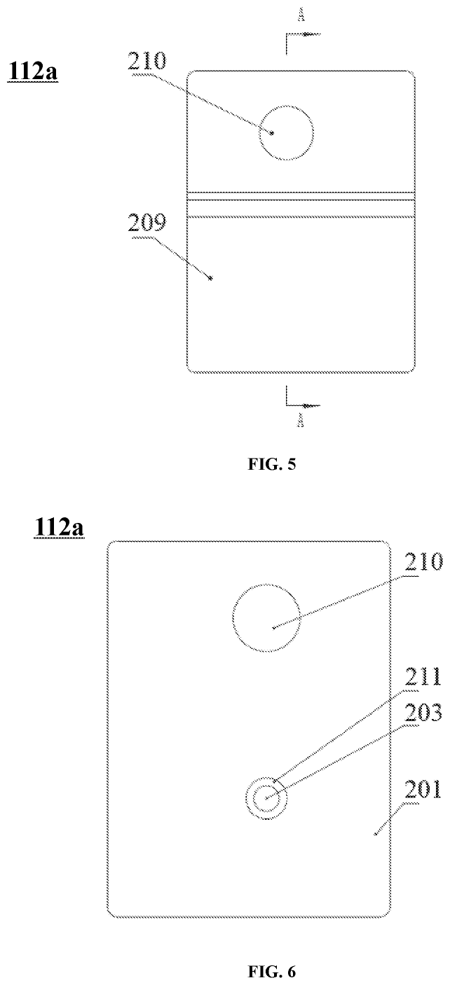

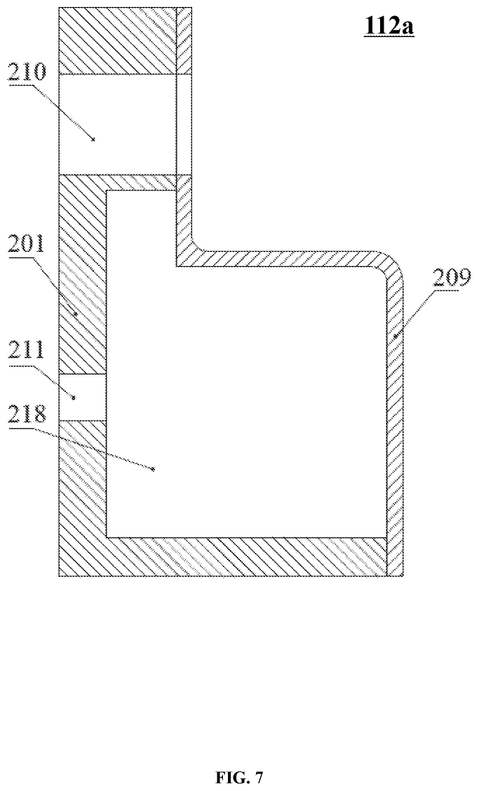

The lock body 112a may include a housing, an electromagnet 202, a lock pin 203, a first circlip 207, a second circlip 204, a compression spring 205, a magnetic core 206, a detection switch 208, or the like, or any combination thereof. The housing may form an accommodation space (e.g., an accommodation space 218 as shown in FIG. 7) for accommodating and protecting one or more internal components of the lock body 112a (e.g., the electromagnet 202, the magnetic core 206, the detection switch 208, etc.). In some embodiments, the housing may be an integral part or include a plurality of detachable components. For example, the housing may include a right housing 201 and a left housing 209 as illustrated in FIGS. 3 and 4. The housing may be made of any suitable material. In some embodiments, the housing may be made of one or more opaque materials, such as metal (e.g., stainless steel, aluminum alloy, cast iron, or the like). More descriptions of the housing may be found elsewhere in the present disclosure (e.g., FIGS. 5-7 and descriptions thereof).

The electromagnet 202 may include a sliding hole. The magnetic core 206 may be slidably mounted within the sliding hole and mechanically connected to the lock pin 203. Under the action of the electromagnet 202, the magnetic core 206 may move and drive the lock pin 203 to slide along the sliding hole of the electromagnet 202. In some embodiments, the lock 110a may further include a current control switch configured to control the direction of a current applied to the electromagnet 202, so as to control the positive and negative poles of the electromagnet 202. For example, the direction of the current applied to the electromagnet 202 may be changed in order to change the direction of the magnetic force applied to the magnetic core 206, which in turn, may change the sliding direction of the magnetic core 206 and the lock pin 203. In this way, driven by the magnetic force, the lock pin 203 may be inserted into a locking hole 220 of the locking member 114a to lock the vehicle 200 or retracted from the locking hole 220 to unlock the vehicle 200.

The detection switch 208 may be configured to detect the position of the magnetic core 206. In some embodiments, the housing of the lock 110a may be made of one or more opaque materials. The position of the magnetic core 206 detected by the detection switch 208 may indicate the state of the electromagnet 202 and the magnetic core 206, as well as the position of the lock pin 203. In some embodiments, the detection switch 208 may be mounted within the housing of the lock 110a. For example, the detection switch 208 may be located on a side of the electromagnet 202 away from the lock pin 203 (or a locking hole of the locking member 114a), e.g., the left side of the electromagnet 202 as shown in FIGS. 3 and 4. The detection switch 208 may have a U-shape, a ring shape, or any other shape. For example, the detection switch 208 may have a U-shape, and the magnetic core 206 may pass through the middle of the U-shaped detection switch 208. In this way, the detection switch 208 may detect the position of the magnetic core 206 more accurately and efficiently.

In some embodiments, the detection switch 208 may include a distance sensor configured to detect the distance between the distance sensor and the magnetic core 206. For example, the magnetic core 206 may move into a detection area of the detection switch 208 under the action of the electromagnet 202. If the distance between the distance sensor and the magnetic core 206 decreases, the distance sensor may determine that the lock pin 203 is being retracted from the locking hole 220 and transmit a signal the electromagnet 202. The current applied to the electromagnet 202 may be controlled according to the signal by, for example, the current control switch as aforementioned. Merely by way of example, if the distance between the distance sensor and the magnetic core 206 reaches a preset value, the distance sensor may determine that the lock pin 203 has been completely retracted from the locking hole 220. The distance sensor may transmit a signal to the electromagnet 202 to adjust or cut off the current applied to the electromagnet 202, in order to stop the magnetic core 206 and the lock pin 203 from moving. This may prevent the magnetic core 206 from colliding with the housing of the lock body 112a or the detection switch 208.

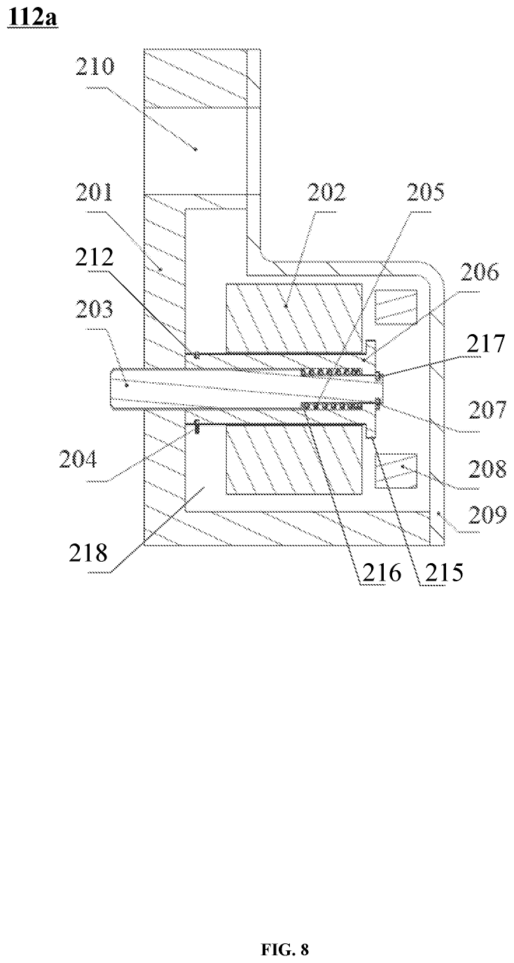

In some embodiments, the position of the lock pin 203 may be controlled and/or restricted by one or more of the second circlip 204, the compression spring 205, and the first circlip 207. More descriptions regarding the control and/or restriction of the position of the lock pin 203 may be found elsewhere in the present disclosure. See, e.g., FIGS. 8 to 10 and relevant descriptions thereof.

The locking member 114a may include at least one locking hole 220 and optionally a wheel sensor 223. The lock pin 203 may be inserted into the at least one locking hole 220 to lock the vehicle 200.

The wheel sensor 223 may be configured to detect the rotational state of the wheel 130 to prevent the lock pin 203 from being inserted into the at least one locking hole 220 while the wheel 130 is still rotating. The wheel sensor 223 may be mounted on the locking member 114a as shown in FIG. 3 or the housing of the lock 110a. In some embodiments, the wheel sensor 223 may include a distance sensor, a speed sensor, an infrared sensor, or any other sensor that can detect the rotational state of the wheel 130, or any combination thereof. For example, the wheel sensor 223 may include a second distance sensor configured to detect the spokes 132 of the vehicle 200. If a spoke 132 passes through a detection area of the second distance sensor, the second distance sensor may determine that the wheel 130 is rotating. If no spokes pass through the detection area of the second distance sensor during a preset period, the second distance sensor may determine that the wheel 130 remains stationary and the lock pin 203 may be caused to lock the vehicle 200. Optionally, a timer may be used together with the second distance sensor to detect the rotational state of the wheel 130. As another example, the wheel sensor 223 may include a speed sensor configured to measure the rotational speed of the wheel 130. If the rotational speed greater than zero, the speed sensor may determine that the wheel 130 is rotating. If the rotational speed is equal to or substantially equal zero, the speed sensor may determine that the wheel 130 remains stationary and the lock pin 203 may be caused to lock the vehicle 200.

FIGS. 5-7 are schematic diagrams illustrating a front view, a rear view, and a sectional view of the housing of the lock body 112a, respectively, according to some embodiments of the present disclosure. The front view and the rear view of the housing may be seen from the left side and the right side of the lock body 112a as shown in FIGS. 2 to 4, respectively.

As shown in FIGS. 5-7, the housing may include a right housing 201 and a left housing 209. The right housing 201 and the left housing 209 may form an accommodation space 218 for accommodating and protecting one or more internal components of the lock body 112a (e.g., the electromagnet 202, the magnetic core 206, the detection switch 208 as described in connection with FIG. 2). Optionally, the accommodation space 218 may be an enclosed space.

The right housing 201 may include a mounting hole 210 and a pin hole 211. The pin hole 211 may be spatially connected to the accommodation space 218, wherein the lock pin 203 may be inserted into or retracted from the accommodation space 218 through the pin hole 211. The mounting hole 210 may be configured to mount the lock body 112a to a vehicle (e.g., the vehicle 200 as shown in FIG. 2). For example, the mounting hole 210 may be a straight hole, and the lock body 112a may be mounted on the frame 120 of the vehicle 200 using a bolt. As another example, the mounting hole 210 may be a threaded hole, and the frame 120 of the vehicle 200 may include a straight hole. A bolt may pass through the straight hole of the frame 120 and be inserted into the mounting hole 210 to mount the lock body 112a on the frame 120. In some embodiments, the mounting hole 210 may be a straight hole including a counter bore. The head of the bolt for mounting the lock body 112a may be accommodated within the counter bore without being exposed, which may achieve a more beautiful and safer layout to avoid scratches by the bolt.

The right housing 201 and the left housing 209 may be detachably connected with each other through, for example, a bolted connection, a snap connection, a screw connection, a glue connection, or the like. For example, the left housing 209 may include a straight hole matching the mounting hole 210. The blot for mounting the right housing 201 on the vehicle 200 may also mount the left housing 209 on the right housing 201. In some embodiments, the left housing 209 may have a Z-shape, and the right housing 201 and the left housing 209 may form a d-shaped housing as shown in FIG. 7. The d-shaped housing may reduce the overall volume of the lock body 112a and improve the installation stability of the lock body 112a. In some alternative embodiments, the right housing 201 and the left housing 209 may form a housing having another shape, such as a cube.

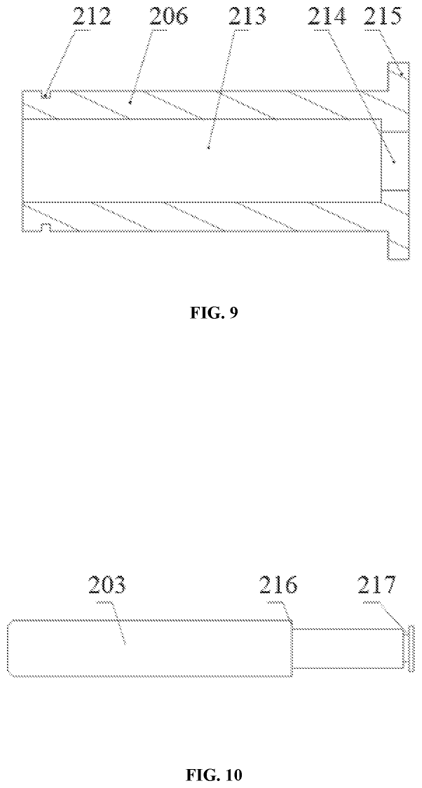

FIG. 8 is a schematic diagram illustrating a sectional view of the lock body 112a according to some embodiments of the present disclosure. FIG. 9 is a schematic diagram illustrating a sectional view of the magnetic core 206 of the lock body 112a according to some embodiments of the present disclosure. FIG. 10 is a schematic diagram illustrating a sectional view of the lock pin 203 of the lock body 112a according to some embodiments of the present disclosure.

As shown in FIG. 8, the electromagnet 202, the lock pin 203, the second circlip 204, the compression spring 205, the magnetic core 206, the first circlip 207, and the detection switch 208 of the lock body 112a may be located within the accommodation space 218 formed by the right housing 201 and the left housing 209. The magnetic core 206 may be mechanically connected to the lock pin 203 to drive the movement of the lock pin 203 under the action of the electromagnet 202. For example, as shown in FIGS. 8 and 10, the lock pin 203 may include an abutting step 216 and a first slot 217. The abutting step 216 may abut against one end of the compression spring 205. The first slot 217 may be located at an end of the lock pin 203 that is away from a locking hole (e.g., the locking hole 220 not shown in FIG. 8). The first circlip 207 may be mounted within the first slot 217 to establish a mechanical connection between the lock pin 203 and the magnetic core 206. In such cases, the lock pin 203 may move together with the magnetic core 206 under the action of the electromagnet 202. For example, the movement of the magnetic core 206 away from the locking hole 220 may drive the lock pin 203 to move away from the locking hole 220, so as to retract the lock pin 203 from the locking hole 220.

As shown in FIG. 9, the magnetic core 206 may include a through hole, through which the lock pin 203 may pass. In some embodiments, the through hole of the magnetic core 206 may be a straight hole including a reset section 213 and a sliding section 214. The lock pin 203 may be inserted into the through hole through the sliding section 214. The compression spring 205 may be mounted within the reset section 213 as illustrated in FIG. 8. In some embodiments, the sliding section 214 may be located at an end of the reset section 213 that is away from the locking hole 220. Additionally or alternatively, the diameter of the reset section 213 may be greater than the diameter of the sliding section 214.

In operation, the lock pin 203 may be slidably mounted within the through hole of the magnetic core 206. When the magnetic core 206 moves toward the locking hole 220 under the action of the electromagnet 202, the lock pin 203 may move together with the magnetic core 206, for example, under the action of gravity. An end of the lock pin 203 may abut against the locking member 114a and stop moving when it reaches a position close to the at least one locking hole 220. The magnetic core 206 may be driven by the electromagnet 202 and keep moving toward the at least one locking hole 220 to reach a predetermined position. Merely by way of example, the magnetic core 206 may be deemed as reaching its predetermined position if a second end of the magnetic core 206 adjacent to the locking hole 220 (e.g., the left end of the magnetic core 206 as shown in FIG. 9) abuts against the inner wall of the housing of the lock body 112a.

In some alternative embodiments, as shown in FIGS. 8 and 9, the magnetic core 206 may include a stopping member 215 at a first end of the magnetic core 206 at which the sliding section 214 is located (e.g., the right end of the magnetic core 206 as shown in FIG. 9). Additionally or alternatively, the magnetic core 206 may include a second slot 212 located at the out wall of the second end of the magnetic core 206 opposite to the first end of the magnetic core 206 (e.g., the left end of the magnetic core 206 as shown in FIG. 9). The second circlip 204 may be mounted within the second slot 212. The position and movement of the magnetic core 206 may be restricted by the stopping member 215 and the second circlip 204. For example, the movement of the magnetic core 206 away from the at least one locking hole 220 may be restricted by the second circlip 204, and the movement of the magnetic core 206 toward the at least one locking hole 220 may be restricted by the stopping member 215. In some embodiments, in order to mount the magnetic core 206 on the electromagnet 202, the second end of the magnetic core 206 including the second slot 212 may be inserted into the sliding hole of the electromagnet 202, and the second circlip 204 may be mounted within the second slot 212 after the second slot 212 passes through the sliding hole.

The compression spring 205 may be used as a reset device configured to drive the lock pin 203 to move close to or away from the electromagnet 202, so as to retract the lock pin 203 from or insert the lock pin 203 into a locking hole 220. For example, the compression spring 205 may apply a force on the lock pin 203 to drive the lock pin 203 to move away from the electromagnet 202, so as to insert the lock pin 203 into the locking hole 220.

As described above, driven by the electromagnet 202 and the magnetic core 206, the lock pin 203 may be inserted into or retracted from a locking hole 220 of the locking member 114a. In some occasions, the position of the lock pin 203 may not match the position of the locking hole 220. The lock pin 203 may strike and cause damage to the locking member 114a if the current is applied to the electromagnet 202 continuously. In order to avoid the damage to the locking member 114a, after the magnetic core 206 moves to a position close to the locking hole 220 (e.g., a position restricted by the stopping member 215 or the inner wall of the housing as aforementioned), the current applied to the electromagnet 202 may be cut off. Then the compression spring 205 may apply a force on the lock pin 203 to drive the lock pin 203 to move toward the locking hole 220. If the position of the lock pin 203 does not match the position of the locking hole 220, the lock pin 203 may abut against the surface of the locking member 114a without striking the locking member 114a. The lock pin 203 or the locking hole 220 may move with the rotation of the wheel 130, and the lock pin 203 may be inserted into the locking hole 220 when the positions of the locking hole 220 and the lock pin 203 match each other.

In some embodiments, the compression spring 205 may be located at one end of the lock pin 203 or be sleeved on the lock pin 203. Merely by way of example, the compression spring 205 may be sleeved on the lock pin 203. Optionally, the compression spring 205 may be sleeved on an end of the lock pin 203 that is away from the locking hole 220. A first end of the compression spring 205 may be fixedly connected to, for example, the housing of the lock body 112a, the magnetic core 206, or the frame 120. Merely by way of example, the diameter of the reset section 213 may be greater than the diameter of the sliding section 214, and the compression spring 205 may be located within the reset section 213. A first end of the compression spring 205 may abut against the first end of the magnetic core 206 (or an end of the sliding section 214). A second end of the compression spring 205 opposite to the first end of the compression spring 205 may abut against the lock pin 203 (e.g., an abutting step 216 of the lock pin 203 as described in connection with FIG. 10). If the current of the electromagnet 202 is cut off, the compression spring 205 may drive the lock pin 203 to move away from the electromagnet 202 and be inserted into the locking hole 220.

In some embodiments, a sealing measure may be adopted to prevent water and/or dust from entering the accommodation space 218 through the lock pin 203 and causing damage to the components within the accommodation space 218. Merely by way of example, a seal ring may be mounted at the first end of the compression spring 205 that abuts against the first end of the magnetic core 206 and is away from the abutting step 216. The pressure applied by the compression spring 205 on the seal ring may improve the stability of the seal ring. The seal ring may include a silicone gasket, a rubber gasket, or the like.

In some embodiments, the seal ring may be damaged by the compressions and vibrations of the compression spring 205. In order to avoid the damage to the seal, a metal gasket may be mounted between the compression spring 205 and the seal ring. The compression spring 205 may abut against the metal gasket, and the metal gasket may squeeze the seal ring toward the first end of the magnetic core 206, thereby avoiding the damage to the seal ring.

It should be noted that the descriptions regarding FIGS. 2 to 10 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the vehicle 200 may include one or more additional components and/or one or more components of the vehicle 200 described above may be omitted. Additionally or alternatively, two or more components of the vehicle 200 may be integrated into a single component. A component of the vehicle 200 may be implemented on two or more sub-components. In addition, the shape, size, position of a component of the vehicle 200 shown in FIGS. 2 to 10 are illustrative and not intended to be limiting. For example, the wheel sensor 223 may be located on the housing of the lock body 112a or another position that can detect the rotational state of the wheel 130.

In some embodiments, a component of the vehicle 200 described above may be replaced by another component that can implement same or similar functions. For example, the reset device may include a tension spring other than the compression spring 205. The sliding section 214 may be located at an end of the reset section 213 that is closer to the locking hole 220 (e.g., the left end of the reset section 213 as shown in FIG. 8). One end of the tension spring may be fixedly connected to the lock pin 203, and the other end of the tension spring may be fixed on the housing of the lock body 112a or the magnetic core 206. The tension spring may apply a force on the lock pin 203 to drive the lock pin 203 to move away from the electromagnet 202, so as to insert the lock pin 203 into the locking hole 220. As another example, the reset device may include one or more other elastic structures, such as a rubber band, that can insert the lock pin 203 into the locking hole 220.

In some embodiments, the reset device may be omitted. The through hole of the magnetic core 206 may be a threaded hole. An end of the lock pin 203 that is away from the locking hole 220 may include an external thread matching the threaded hole of the magnetic core 206. A threaded connection may be established between the lock pin 203 and the magnetic core 206. In such cases, the lock pin 203 may move together with the magnetic core 206 under the action of the electromagnet 202, so as to retract the lock pin 203 from or insert the lock pin 203 into the locking hole 220.

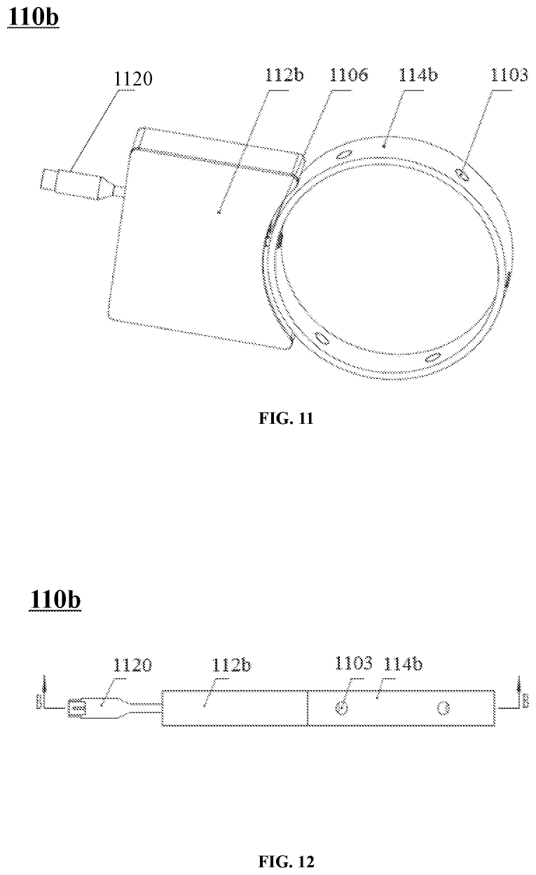

FIG. 11 is a schematic diagram illustrating a perspective view of an exemplary lock 110b according to some embodiments of the present disclosure. FIG. 12 is a schematic diagram illustrating a top view of the lock 110b according to some embodiments of the present disclosure.

As shown in FIGS. 11 and 12, the lock 110b may include a lock body 112b and a locking member 114b. The lock body 112b may include a lock pin 1106 and an electric wire 1120. The electric wire 1120 may supply power to one or more internal components of the lock body 112b (e.g., a driving motor). The locking member 114b may include at least one locking hole 1103. The lock pin 1106 may be inserted into the at least one locking hole 1103 to lock a vehicle (not shown in FIGS. 11 and 12).

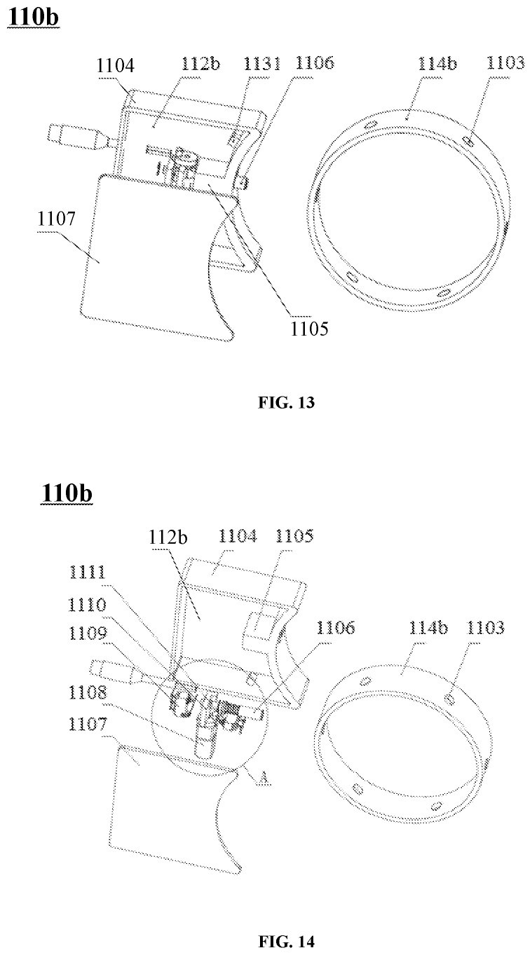

For illustration purposes, partial enlarged views of the lock 110b are illustrated in FIGS. 13-15. As shown in FIGS. 13-15, the lock body 112b may include a housing, a lock pin 1106, a driving member 1108, a second detection switch 1109, a transmission mechanism 1110, a first detection switch 1111, and a wheel sensor 1131.

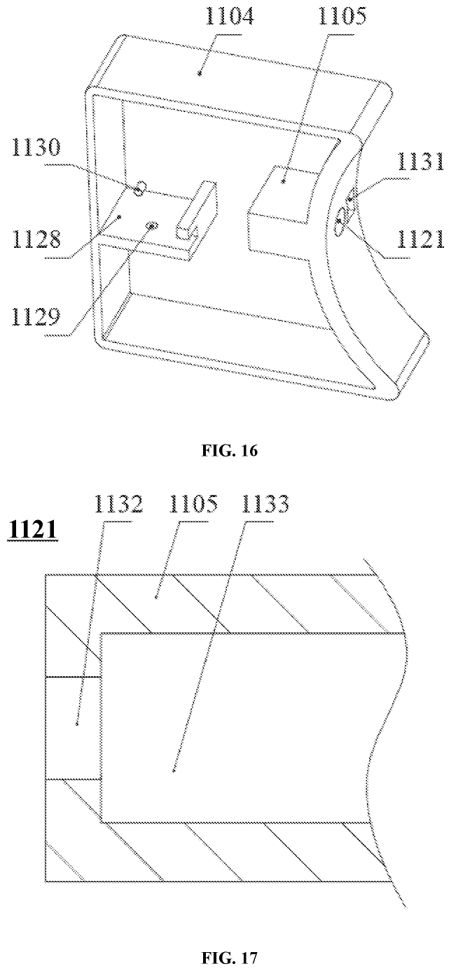

The housing of the lock body 112b may include a main housing 1104, a second mounting member 1105, and a housing cover 1107. The main housing 1104 and the housing cover 1107 may form an accommodation space to accommodate and protect one or more internal components of the lock body 112b (e.g., the driving member 1108, the second detection switch 1109, the transmission mechanism 1110, the first detection switch 1111, at least a portion of the lock pin 1106, etc.). More descriptions of the housing of the lock body 112b may be found elsewhere in the present disclosure (e.g., FIGS. 16-17 and descriptions thereof).

The lock pin 1106 may be mounted on the second mounting member 1105 of the main housing 1104 and mechanically connected to the transmission mechanism 1110. The driving member 1108 may be mechanically connected to the transmission mechanism 1110. The driving member 1108 may be configured to drive the movement of the transmission mechanism 1110, which in turn, may drive the movement of the lock pin 1106. For example, driven by the driving member 1108, the lock pin 1106 may be inserted into or retracted from the at least one locking hole 1103. The driving member 1108 may include, for example, a driving motor, a driving handle, or any other driving device.

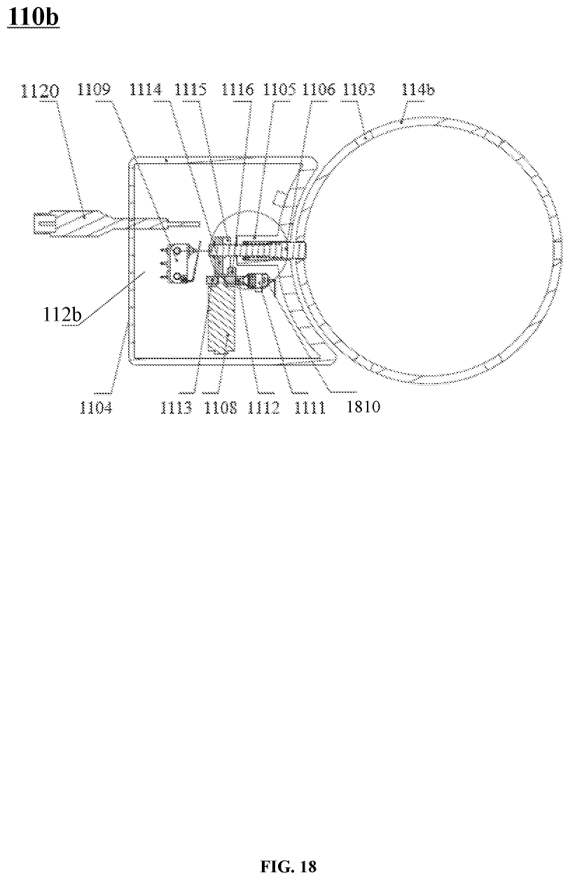

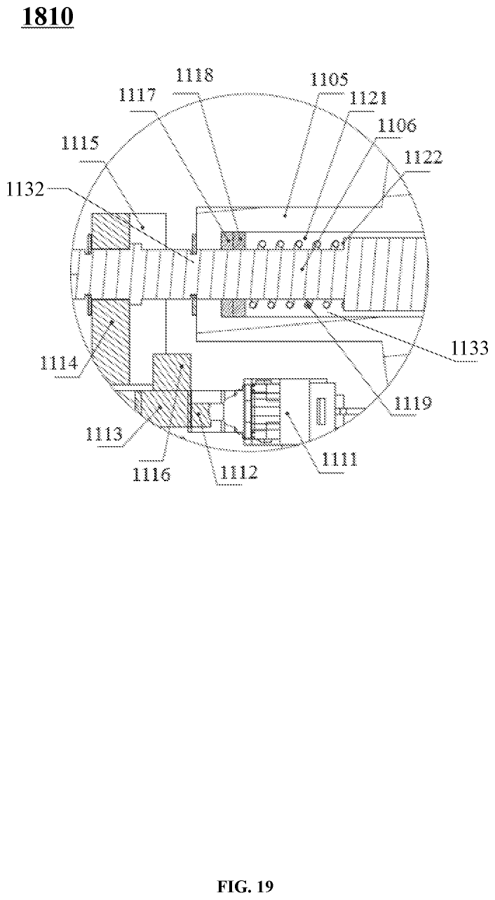

The lock pin 1106 may have a shape of a cylindrical rod, a square column, a triangular prism, a hexagonal prism, or any other shape that matches the at least one locking hole 1103 of the locking member 114b. In some embodiments, the lock pin 1106 may include a reset device, a seal ring 1117, and a metal gasket 1118. The reset device of the lock pin 1106 may be configured to retract the lock pin 1106 from the locking hole 1103 or insert the lock pin 1106 into the locking hole 1103. Merely by way of example, the reset device of the lock pin 1106 may include a first compression spring 1119. More descriptions of the reset device, the seal ring 1117, and the metal gasket 1118 of the lock pin 1106 may be found elsewhere in the present disclosure (e.g., FIGS. 18-19 and descriptions thereof).

The second detection switch 1109 may be configured to detect the position of the lock pin 1106 by detecting the state of the transmission mechanism 1110. For example, the second detection switch 1109 may determine whether the lock pin 1106 has been retracted from the at least one locking hole 1103 according to the position of the transmission mechanism 1110. In some embodiments, the second detection switch 1109 may include a switch (e.g., a first micro switch). The transmission mechanism 1110 may include a contact protrusion 1112 located on the sidewall of a transmission wheel 1113 of the transmission mechanism 1110. After the lock pin 1106 is retracted from the at least one locking hole 1103, the first micro switch may be in contact with the contact protrusion 1112. The first micro switch and the contact protrusion 1112 may form a closed loop, and the first micro switch may be powered. A signal may then be transmitted to the driving member 1108 to indicate that the first micro switch is powered, and the driving member 1108 may stop driving the lock pin 1106.

The first detection switch 1111 may be configured to detect the position of the lock pin 1106 by detecting the state of the transmission mechanism 1110. For example, the first detection switch 1111 may determine whether the lock pin 1106 has been inserted into the at least one locking hole 1103 according to the position of the transmission mechanism 1110. In some embodiments, the first detection switch 1111 may include a switch (e.g., a second micro switch). After the lock pin 1106 is inserted into the at least one locking hole 1103, the second micro switch may be in contact with the contact protrusion 1112. The second micro switch and the contact protrusion 1112 may form a closed loop, and the second micro switch may be powered. A signal may then be transmitted to the driving member 1108 to indicate that the second micro switch is powered, and the driving member 1108 may stop driving the lock pin 1106. In some embodiments, the first detection switch 1111 may be located below the second mounting member 1105. In some embodiments, the second detection switch 1109 and/or the first detection switch 1111 may be omitted.

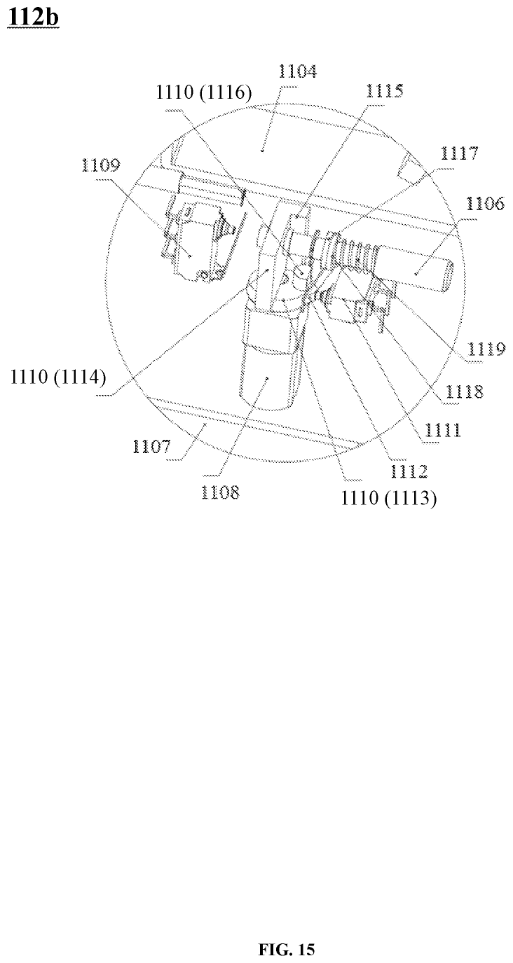

The transmission mechanism 1110 may include a transmission wheel 1113, a protrusion 1116, and a first linkage member 1114. The first linkage member 1114 may be mechanically (e.g., fixedly) connected to the lock pin 1106. For example, the first linkage member 1114 and the lock pin 1106 may form an integral part or be fixedly connected to each other via, for example, a riveting connection or a welding connection. The driving member 1108 may be mounted on a first side of the transmission wheel 1113 (e.g., a bottom side of the transmission wheel 1113 as shown in FIG. 15). In some embodiments, the transmission wheel 1113 may be coaxial with the driving member 1108 and rotate driven by the driving member 1108.

The protrusion 1116 may be located on a second side of the transmission wheel 1113 (e.g., a top side of the transmission wheel 1113 as shown in FIG. 15) that is opposite to the first side of the transmission wheel 1113. The protrusion 1116 may abut against at least a portion of the first linkage member 1114 (e.g., the side of the first linkage member 1114 adjacent to the lock pin 1106). For example, the protrusion 16 may be a column having a flat side surface that fits the first linkage member 1114. In some embodiments, the protrusion 1116 may rotate around the central axis of the transmission wheel 1113 with the rotation of the transmission wheel 1113. The rotation of the protrusion 1116 may drive the first linkage member 1114 to move toward or away from the at least one locking hole 1103, which in turn, may cause the lock pin 1106 to be inserted into or retracted from the at least one locking hole 1103.

In some embodiments, the first linkage member 1114 may be configured as a plate. Optionally, the first linkage member 1114 may include a stopping member 1115 abutting against the protrusion 1116 to restrict the movement (e.g., rotation) of the transmission wheel 1113. Merely by way of example, as shown in FIG. 15, the stopping member 1115 may be located at a first end of the first linkage member 1114. The first linkage member 1114 and the stopping member 1115 may form an L-shaped plate. The stopping member 1115 may be integrated into the first linkage member 1114 or be an independent component detachably mounted on the first linkage member 1114. The driving member 1108 may drive the transmission wheel 1113 to rotate clockwise, and the rotation of the transmission wheel 1113 may be restricted by the stopping member 1115 at the first end of the first linkage member 1114. Additionally or alternatively, another stopping member (not shown in FIG. 15) may be arranged at a second end of the first linkage member 1114 that is opposite to the first end of the first linkage member 1114. The driving member 1108 may drive the transmission wheel 1113 to rotate counterclockwise, and the rotation of the transmission wheel 1113 may be restricted by the stopping member at the second end of the first linkage member 1114.

It should be noted that the transmission mechanism 1110 described above is merely provided for the purposes of illustration, and not intended to limit the scope of the present disclosure. In some embodiments, the transmission mechanism 1110 may include a transmission cam and a second linkage member. The second linkage member may be mechanically (e.g., fixedly) connected to the lock pin 1106. The transmission cam may be mounted on the driving member 1108. A sidewall of the transmission cam may abut against at least a portion of the second linkage member (e.g., the side of the second linkage member adjacent to the lock pin 1106). Driven by the driving member 1108, the transmission cam may move, which may cause the second linkage member to move. The movement of the second linkage member may cause the lock pin 1106 to be inserted into or retracted from the at least one locking hole 1103.

In some alternative embodiments, the transmission mechanism 1110 may include one or more other transmission components including, for example, a pair of gear and worm, a pair of worm and gear, a threaded screw, or the like. Merely by way of example, the transmission mechanism 1110 may include a transmission gear and a transmission rack. The transmission rack may be mechanically (e.g., fixedly) connected to the lock pin 1106 and mesh with the transmission gear. Driven by the rotation of the transmission gear, the transmission rack may move. The movement of the transmission rack may cause the lock pin 1106 to be inserted into or retracted from the at least one locking hole 1103.

The wheel sensor 1131 may be mounted within the housing of the lock body 112b and configured to detect the rotational state of a wheel of a vehicle to be locked. In some embodiments, the wheel sensor 1131 may include a distance sensor, a speed sensor, an infrared sensor, or any other sensor that can detect the rotational state of the wheel. In some embodiments, the wheel sensor 1131 may be similar to the wheel sensor 223 as described in connection with FIG. 3, and the descriptions thereof are not repeated here.

FIG. 16 is a schematic diagram illustrating an exemplary main housing 1104 according to some embodiments of the present disclosure. FIG. 17 is a schematic diagram illustrating a sectional view of an exemplary second mounting hole 1121 according to some embodiments of the present disclosure.

As shown in FIGS. 16-17, the main housing 1104 may include the second mounting member 1105, a first mounting member 1128, a first mounting hole 1129, and a positioning column 1130. The second mounting member 1105 may include a second mounting hole 1121, wherein the lock pin 1106 may be slidably mounted within the second mounting hole 1121. For example, the lock pin 1106 may extend out from the main housing 1104 from the second mounting hole 1121 and be inserted into a locking hole 1103.

In some embodiments, as shown in FIG. 17, the second mounting hole 1121 may include a sliding section 1132 and a reset section 1133. The lock pin 1106 may be inserted into the second mounting hole 1121 via the sliding section 1132. The first compression spring 1119 may be mounted within the reset section 1133. In some embodiments, the sliding section 1132 may be located at an end of the reset section 1133 that is away from the at least one locking hole 1103. Additionally or alternatively, the diameter of the sliding section 1132 may be less than the diameter of the reset section 1133. A first end of the first compression spring 1119 may abut against an end of the sliding section 1132. The first compression spring 1119 may apply a force on the lock pin 1106 to insert the lock pin 1106 into the at least one locking hole 1103. The force applied by the first compression spring 1119 may be opposite to the force applied by the protrusion 1116 on the first linkage member 1114.

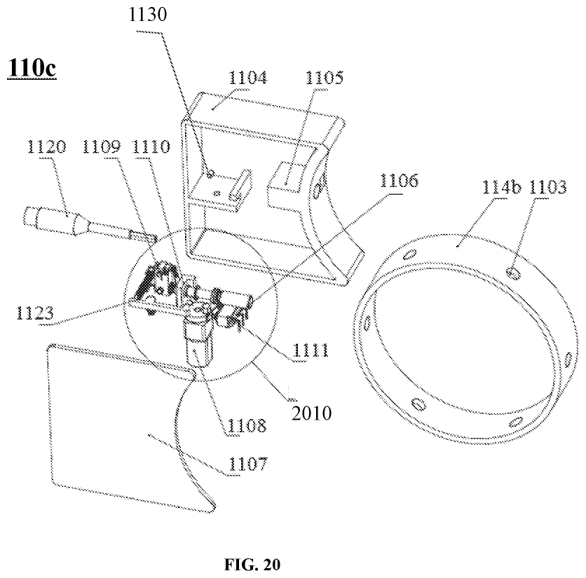

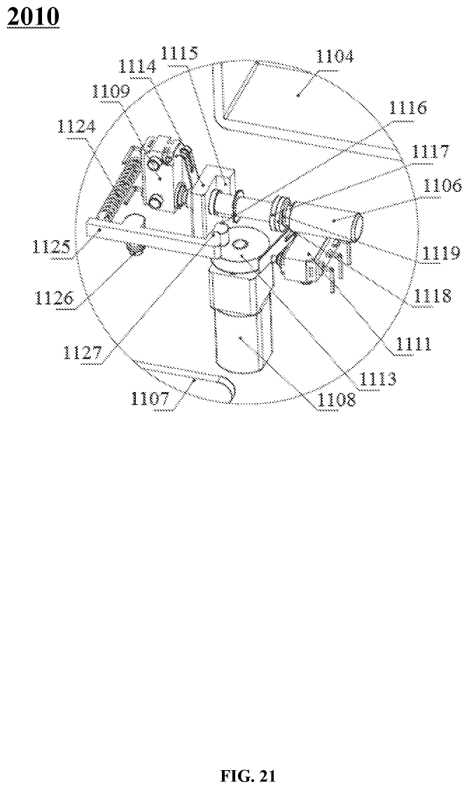

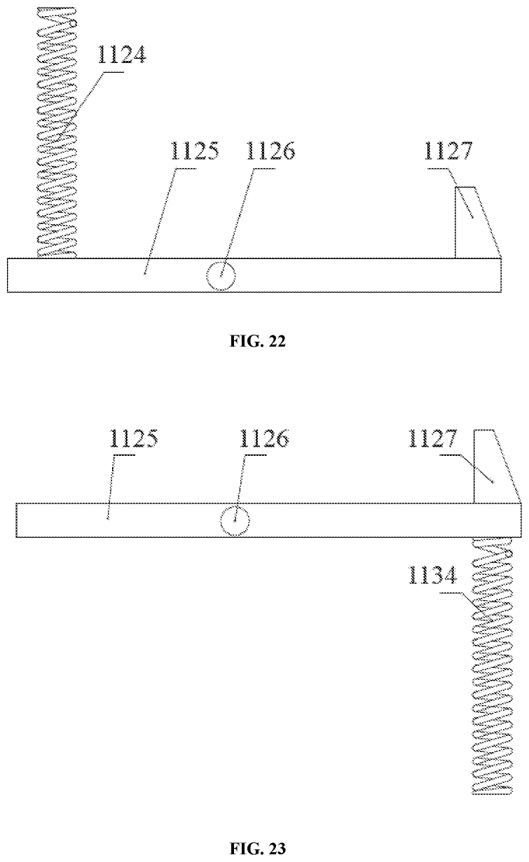

The positioning column 1130 may be located on the first mounting member 1128 and configured to mount a second compression spring (e.g., a second compression spring 1124 as shown in FIG. 22). More descriptions of the positioning column 1130 may be found elsewhere in the present disclosure (e.g., FIGS. 20-21 and descriptions thereof). In some embodiments, the positioning column 1130 may be omitted.

FIG. 18 is a schematic diagram illustrating a sectional view of the lock 110b according to some embodiments of the present disclosure. FIG. 19 is a schematic diagram illustrating an enlarged view of a portion 1810 of the lock 110b according to some embodiments of the present disclosure.

As shown in FIGS. 18-19, the portion 1810 of the lock 110b may include a first compression spring 1119 mounted on the lock pin 1106. The first compression spring 1119 may be an exemplary reset device, which is located in the reset section 1133 and configured to retract the lock pin 1106 from the at least one locking hole 1103 or insert the lock pin 1106 into the at least one locking hole 1103. For illustration purposes, the following descriptions regarding the reset device of the lock 110b are described with reference to the first compression spring 1119, and not intended to limit the scope of the present disclosure. Merely by way of example, the protrusion 1116 and the first linkage member 1114 may be configured to retract the lock pin 1106 from the at least one locking hole 1103. The first compression spring 1119 may apply a force, which is opposite to the force applied by the protrusion 1116 on the first linkage member 1114, on the lock pin 1106 to insert the lock pin 1106 into the at least one locking hole 1103.

In some embodiments, in order to insert the lock pin 1106 into the at least one locking hole 1103, the driving member 1108 may stop applying a force to the transmission mechanism 1110. In such cases, no force may be applied on the lock pin 1106 to retract the lock pin 1106 from the at least one locking hole 1103. The lock pin 1106 may be inserted into the at least one locking hole 1103 under the action of the first compression spring 1119. If the position of the lock pin 1106 matches the position of the at least one locking hole 1103, the lock pin 1106 may be inserted into the at least one locking hole 1103 by the first compression spring 1119. If the position of the lock pin 1106 does not match the position of the at least one locking hole 1103, the lock pin 1106 may abut against the surface of the locking member 114b due to the first compression spring 1119. The lock pin 1106 or the at least one locking hole 1103 may move with the rotation of the wheel, and the lock pin 1106 may be driven by the first compression spring 1119 and inserted into the at least one locking hole 1103 when the positions of the at least one locking hole 1103 and the lock pin 1106 match each other. The first compression spring 1119 may prevent damages to the lock pin 1106, the driving member 1108, and the transmission mechanism 1110 when the position of the lock pin 1106 does not match the position of the at least one locking hole 1103.

In some embodiments, the first compression spring 1119 may be located at one end of the lock pin 1106 or be sleeved on the lock pin 1106. For example, a first end of the first compression spring 1119 may be fixedly connected to the housing of the lock body 112b or a frame of the vehicle to be locked. A second end of the first compression spring 1119 opposite to the first end of the first compression spring 1119 may abut against the lock pin 1106 (e.g., an end of the lock pin 1106 that is away from the at least one locking hole 1103, an abutting step 1122 of the lock pin 1106).

In some embodiments, the sliding section 1132 of the second mounting hole 1121 may be located at an end of the reset section 1133 that is away from the at least one locking hole 1103 as shown in FIG. 18. The diameter of the reset section 1133 may be greater than the diameter of the sliding section 1132, and the first compression spring 1119 may be located within the reset section 1133. The first end of the first compression spring 1119 may abut against an end of the sliding section 1132. The second end of the first compression spring 1119 opposite to the first end of the first compression spring 1119 may abut against the lock pin 1106 (e.g., the abutting step 1122 of the lock pin 1106). The first compression spring 1119 may apply a force on the lock pin 1106 to insert the lock pin 1106 into the at least one locking hole 1103, while the driving member 1108 may apply a force on the lock pin 1106 through the transmission mechanism 1110 to retract the lock pin 1106 from the at least one locking hole 1103.

In some alternative embodiments, the sliding section 1132 may be located at an end of the reset section 1133 that is adjacent to the at least one locking hole 1103. The diameter of the reset section 1133 may be greater than the diameter of the sliding section 1132, and the first compression spring 1119 may be located within the reset section 1133. An end (e.g., the second end) of the first compression spring 1119 may abut against one end of the sliding section 1132. The first compression spring 1119 may apply a force on the lock pin 1106 to retract the lock pin 1106 from the at least one locking hole 1103, while the driving member 1108 may apply a force on the lock pin 1106 through the transmission mechanism 1110 to insert the lock pin 1106 into the at least one locking hole 1103.

In some embodiments, a sealing measure may be adopted to prevent water and/or dust from entering the accommodation space through the second mounting hole 1121 and causing damage to the components within the accommodation space. Merely by way of example, a seal ring 1117 may be mounted at the first end of the first compression spring 1119 that abuts against the sliding section 1132 and is away from the abutting step 1122. The pressure applied by the first compression spring 1119 on the seal ring 1117 may improve the stability of the seal ring 1117. The seal ring 1117 may include a silicone gasket, a rubber gasket, or the like. In some embodiments, the seal ring 1117 may be damaged by the compressions and vibrations of the first compression spring 1119. In order to avoid the damage to the seal ring 1117, a metal gasket 1118 may be mounted between the first compression spring 1119 and the seal ring 1117 as shown in FIG. 19. The first compression spring 1119 may abut against the metal gasket, and the metal gasket may squeeze the seal ring 1117 toward the end of the sliding section 1132, thereby avoiding the damage to the seal ring 1117.

In some embodiments, the first compression spring 1119 may be replaced by another reset device, such as a first tension spring or another elastic structure (e.g., a rubber band). For example, a first end of the first tension spring may be fixedly connected to the lock pin 1106, and a second end of the first tension spring may be fixed on the housing of the lock body 112b. If the sliding section 1132 of the second mounting hole 1121 is located at an end of the reset section 1133 adjacent to the at least one locking hole 1103, the ends of the first tension spring may be fixed on an end of the sliding section 1132 and the lock pin 1106, respectively. The first tension spring may apply a force on the lock pin 1106 to insert the lock pin 1106 into the at least one locking hole 1103, while the driving member 1108 may apply a force on the lock pin 1106 through the transmission mechanism 1110 to retract the lock pin 1106 from the at least one locking hole 1103. If the sliding section 1132 of the second mounting hole 1121 is located at an end of the reset section 1133 away from the at least one locking hole 1103, the ends of the first tension spring may be fixed on an end of the sliding section 1132 and the lock pin 1106, respectively. The first tension spring may apply a force on the lock pin 1106 to retract the lock pin 1106 from the at least one locking hole 1103, while the driving member 1108 may apply a force on the lock pin 1106 through the transmission mechanism 1110 to insert the lock pin 1106 into the at least one locking hole 1103.

FIG. 20 is a schematic diagram illustrating an exemplary lock 110c according to some embodiments of the present disclosure. FIG. 21 is a schematic diagram illustrating an enlarged view of a portion 2010 of the lock 110c according to some embodiments of the present disclosure.

As shown in FIGS. 20-21, the lock 110c may be similar to the lock 110b as described in connection with FIGS. 13-15, except that the lock 110c may further include a mechanical locking mechanism 1123. The mechanical locking mechanism 1123 may be configured to lock the first linkage member 1114 or the second linkage member after the lock pin 1106 is retracted from the at least one locking hole 1103. The mechanical locking mechanism 1123 may prevent the first linkage member 1114 or the second linkage member from being moved under the action of the first compression spring 1119. In addition, using the mechanical locking mechanism 1123 may avoid a misoperation of the driving member 1108.

In some embodiments, the mechanical locking mechanism 1123 may include a rotation lever 1125, a locking block 1127, and a rotation shaft 1126. The locking block 1127 may be located at a first side at a first end of the rotation lever 1125 (e.g., the inner side at the right end of the rotation lever 1125 as shown in FIG. 21). The rotation lever 1125 may be mechanically connected to the rotation shaft 1126 and configured to drive the locking block 1127 to abut against the first linkage member 1114 by rotating around the rotation shaft 1126. The rotation shaft 1126 may be mounted on the first mounting member 1128, and the rotation lever 1125 may rotate around the rotation shaft 1126 within the housing of the lock body of the lock 110c.

Optionally, the mechanical locking mechanism 1123 may include an elastic device mechanically connected to the rotation lever 1125 and configured to drive the locking block 1127 to rotate toward the first linkage member 1114. For example, as shown in FIGS. 21 and 22, the elastic device may include a second compression spring 1124. A first end of the second compression spring 1124 may be fixed on the housing of the lock body of the lock 110c, and a second end of the second compression spring 1124 may abut against the first side at a second end of the rotation lever 1125 (e.g., the inner side at the left end of the rotation lever 1125 as shown in FIG. 21). The locking block 1127 and the second end of the second compression spring 1124 may be located at two sides of the rotation shaft 1126. In some embodiments, the inner wall of the main housing 1104 may include a positioning column 1130 as shown in FIG. 20. The rotation lever 1125 may include a second positioning column (not shown in FIG. 20) at the first side at the second end of the rotation lever 1125 (i.e., at which the second end of the second compression spring 1124 is located). The first and second ends of the second compression spring 1124 may be sleeved on the positioning column 1130 and the second positioning column, respectively, so as to stabilize the second compression spring 1124 and prevent the drop of the second compression spring 1124.

The second compression spring 1124 may apply an external thrust on the second end of the rotation lever 1125. The first end of the rotation lever 1125 may apply an internal pressure to the locking block 1127 to push the locking block 1127 toward the first linkage member 1114 or the second linkage member. The locking block 1127 may block the first linkage member 1114 or the second linkage member. Driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the second compression spring 1124. The locking block 1127 may be removed from the moving trajectory of the first linkage member 1114 or the second linkage member if the second compression spring 1124 is pressed. After the first linkage member 1114 or the second linkage member reaches a predetermined position (e.g., a position where it locates when the lock pin 1106 is retracted from the at least one locking hole 1103), the second compression spring 1124 may be released. The released second compression spring 1124 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

In some embodiments, the elastic device may include one or more components other than the second compression spring 1124. For example, the elastic device may include a third compression spring 1134 as shown in FIG. 23. A first end of the third compression spring 1134 may be fixed on the housing of the lock body of the lock 110c, and a second end of the third compression spring 1134 may abut against a second side at the first end of the rotation lever 1125 (e.g., the outer side at the right end of the rotation lever 1125 as shown in FIG. 21). The second side at the first end of the rotation lever 1125 may be opposite to the first side at the first end of the rotation lever 1125. The locking block 1127 and the second end of the third compression spring 1134 may be located on a same side of the rotation shaft 1126.

The third compression spring 1134 may apply a pressure on the first end of the rotation lever 1125, and the locking block 1127 may be pushed toward the inner side of the housing of the lock 110c together with the rotation lever 1125. When the first linkage member 1114 or the second linkage member is located behind the locking block 1127, the locking block 1127 may block the first linkage member 1114 or the second linkage member. This may improve the positioning accuracy of the first linkage member 1114 or the second linkage member, and obviate the need for using the driving member 1108 continuously and save power.

In operation, driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the third compression spring 1134. The locking block 1127 may be removed from the moving trajectory of the first linkage member 1114 or the second linkage member if the third compression spring 1134 is pressed. After the first linkage member 1114 or the second linkage member reaches a predetermined position (e.g., a position where it locates when the lock pin 1106 is retracted from the at least one locking hole 1103), the third compression spring 1134 may be released. The released third compression spring 1134 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

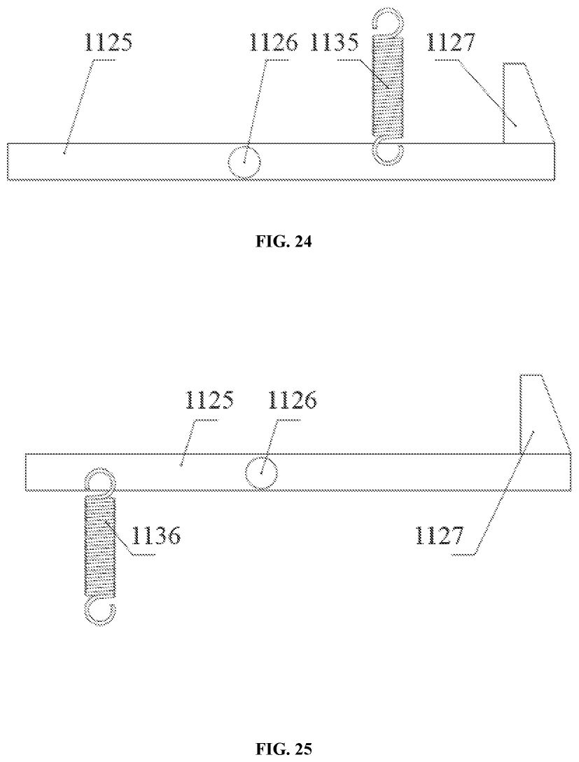

In some embodiments, the elastic device may include a second tension spring 1135 as shown in FIG. 24. A first end of the second tension spring 1135 may be fixed on the housing of the lock body of the lock 110c, and a second end of the second tension spring 1135 may be mechanically connected to the rotation lever 1125. A connection point between the second tension spring 1135 and the rotation lever 1125 may be located on the first side of the rotation lever 1125. The locking block 1127 and the second tension spring 1135 may be located on a same side of the rotation shaft 1126. In some embodiments, the inner wall of the main housing 1104 may include a first connection hole (not shown in figures). The rotation lever 1125 may include a second connection hole at the first side of the rotation lever 1125 (i.e., the position where the connection point between the second tension spring 1135 and the rotation lever 1125 is located). The first and second ends of the second tension spring 1135 may be mechanically connected to the first and second connection holes, respectively, so as to stabilize the second tension spring 1135 and prevent the drop of the second tension spring 1135.

The second tension spring 1135 may apply an external pulling force to the first end of the rotation lever 1125, and the locking block 1127 may be pushed toward the inner side of the housing of the lock 110c together with the rotation lever 1125. When the first linkage member 1114 or the second linkage member is located behind the locking block 1127, the locking block 1127 may block the first linkage member 1114 or the second linkage member. This may improve the positioning accuracy of the first linkage member 1114 or the second linkage member, and obviate the need for using the driving member 1108 continuously and save power.

In operation, driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the second tension spring 1135. The locking block 1127 may be removed from the moving trajectory of the first linkage member 1114 or the second linkage member if the second tension spring 1135 is lengthened by pressing the rotation lever 1125 (e.g., at the second side at the second end of the rotation lever 1125). After the first linkage member 1114 or the second linkage member reaches a predetermined position (e.g., a position where it locates when the lock pin 1106 is retracted from the at least one locking hole 1103), the rotation lever 1125 may be released and the second tension spring 1135 may be reset. The reset second tension spring 1135 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

In some embodiments, the elastic device may include a third tension spring 1136 as shown in FIG. 25. A first end of the third tension spring 1136 may be fixed on the housing of the lock body of the lock 110c, and a second end of the third tension spring 1136 may be mechanically connected to the rotation lever 1125. A connection point between the third tension spring 1136 and the rotation lever 1125 may be located on the second side of the rotation lever 1125. The locking block 1127 and the third tension spring 1136 may be located at two sides of the rotation shaft 1126. In some embodiments, the inner wall of the main housing 1104 may include a third connection hole (not shown in figures). The rotation lever 1125 may include a fourth connection hole at the second side of the rotation lever 1125 (i.e., a position where the connection point between the third tension spring 1136 and the rotation lever 1125 is located). The first and second ends of the third tension spring 1136 may be mechanically connected to the third and fourth connection holes, respectively, so as to stabilize the third tension spring 1136 and prevent the drop of the third tension spring 1136.

The third tension spring 1136 may apply an external pulling force on the second end of the rotation lever 1125. The first end of the rotation lever 1125 may apply an internal pressure to the locking block 1127 to push the locking block 1127 toward the first linkage member 1114 or the second linkage member to block the first linkage member 1114 or the second linkage member. Driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the third tension spring 1136. The locking block 1127 may be removed from the moving trajectory of the first linkage member 1114 or the second linkage member if the third tension spring 1136 is lengthened by pressing the rotation lever 1125 (e.g., at the second side at the second end of the rotation lever 1125). After the first linkage member 1114 or the second linkage member reaches a predetermined position (e.g., a position where it locates when the lock pin 1106 is retracted from the at least one locking hole 1103), the rotation lever 1125 may be released and the third tension spring 1136 may be reset. The reset third tension spring 1136 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

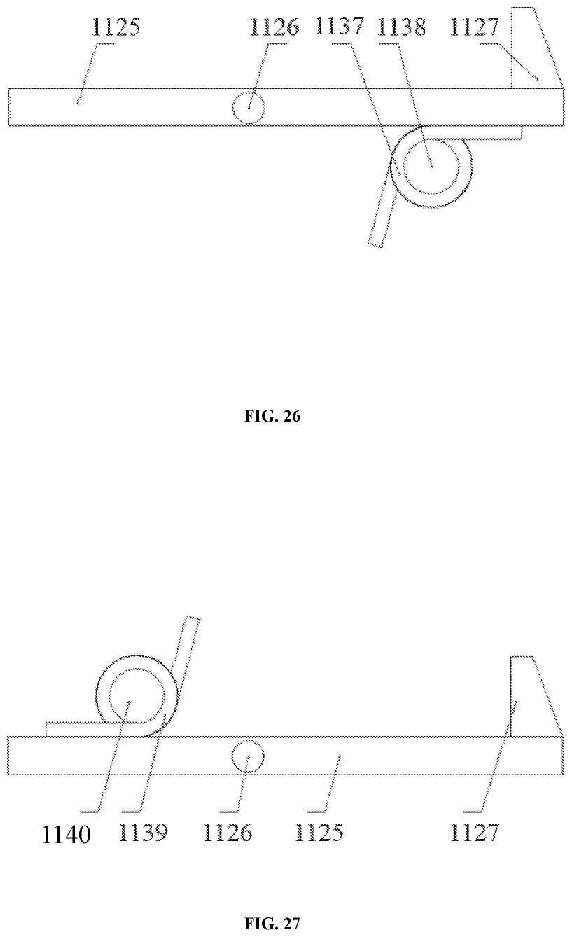

In some embodiments, the elastic device may include a first torsion spring 1137 as shown in FIG. 26. A central axis 1138 of the first torsion spring 1137 and the locking block 1127 may be located on a same side of the rotation shaft 1126. A first protruding end of the first torsion spring 1137 may be fixed. A second protruding end of the first torsion spring 1137 may abut against the second side at the first end of the rotation lever 1125. In some embodiments, the rotation lever 1125 may include a first torsion spring shaft (not shown in FIG. 26) at the second side at the first end of the rotation lever 1125 (i.e., at which the second protruding end of the first torsion spring 1137 located). The first torsion spring 1137 may be sleeved on the first torsion spring shaft and positioned by the first torsion spring shaft. A gap between the first torsion spring shaft and the rotation lever 1125 may ensure the normal operation of the first torsion spring 1137.

The first torsion spring 1137 may apply a pressure on the first end of the rotation lever 1125, and the locking block 1127 may be pushed toward the inner side of the housing of the lock 110c together with the rotation lever 1125. When the first linkage member 1114 or the second linkage member is located behind the locking block 1127 (e.g., on the left side of the locking block 1127 as shown in FIG. 21), the locking block 1127 may block the first linkage member 1114 or the second linkage member. This may improve the positioning accuracy of the first linkage member 1114 or the second linkage member, and obviate the need for using the driving member 1108 continuously and save power.

In operation, driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the first torsion spring 1137. The locking block 1127 may be removed from the moving trajectory of the first linkage member 1114 or the second linkage member if the first torsion spring 1137 is rotated by pressing the rotation lever 1125 on the second side at the second end of the rotation lever 1125. After the first linkage member 1114 or the second linkage member reaches a predetermined position (e.g., a position where it locates when the lock pin 1106 is retracted from the at least one locking hole 1103), the rotation lever 1125 may be released and the first torsion spring 1137 may be reset. The reset first torsion spring 1137 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

In some embodiments, the elastic device may include a second torsion spring 1139 as shown in FIG. 27. A central axis 1140 of the second torsion spring 1139 and the locking block 1127 may be located at two sides of the rotation shaft 1126. A first protruding end of the first torsion spring 1137 may be fixed. A second protruding end of the second torsion spring 1139 may abut against the first side at the second end of the rotation lever 1125. In some embodiments, the rotation lever 1125 may include a second torsion spring shaft (not shown in FIG. 27) at the first side at the second end of the rotation lever 1125 (i.e., at which the second protruding end of the second torsion spring 1139 is located). The second torsion spring 1139 may be sleeved on the second torsion spring shaft and positioned by the second torsion spring shaft. In some embodiments, a gap may exist between the second torsion spring shaft and the rotation lever 1125 may ensure the normal operation of the second torsion spring 1139.

The second torsion spring 1139 may apply an external thrust on the second end of the rotation lever 1125. The first end of the rotation lever 1125 may apply an internal pressure to the locking block 1127 to push the locking block 1127 toward the first linkage member 1114 or the second linkage member. The locking block 1127 may block the first linkage member 1114 or the second linkage member.

In operation, driven by the driving member 1108, the first linkage member 1114 or the second linkage member may drive the lock pin 1106 to be retracted from the at least one locking hole 1103. The locking block 1127 may be positioned at a position along the moving trajectory of the first linkage member 1114 or the second linkage member by the second torsion spring 1139. The locking block 1127 may be removed from the moving trajectory of the first linkage member 1114 or the second linkage member if the second torsion spring 1139 is rotated by pressing the rotation lever 1125 (e.g., at the second side at the second end of the rotation lever 1125). After the first linkage member 1114 or the second linkage member reaches a predetermined position (e.g., a position where it locates when the lock pin 1106 is retracted from the at least one locking hole 1103), the rotation lever 1125 may be released and the second torsion spring 1139 may be reset. The reset second torsion spring 1139 may drive the locking block 1127 to a position along the moving trajectory of the first linkage member 1114 or the second linkage member, so as to block the first linkage member 1114 or the second linkage member and prevent the lock pin 1106 from being inserted into the at least one locking hole 1103.

As described in connection with FIGS. 22-27, the locking block 1127 may be positioned at a position along the moving trajectory of the first linkage member 1114 or the second linkage member by at least one of the elastic devices. The locking block 1127 may be removed from the moving trajectory of the first linkage member 1114 or the second linkage member when the first linkage member 1114 or the second linkage member is driving the lock pin 1106 to be retracted from the at least one locking hole 1103. The locking block 1127 may be driven to a position along the moving trajectory of the first linkage member 1114 or the second linkage member after the first linkage member 1114 or the second linkage member reaches a predetermined position (e.g., a position where it locates when the lock pin 1106 is retracted from the at least one locking hole 1103). In some embodiments, a side of the locking block 1127 away from the rotation shaft 1126 may include a sliding slope. The sliding slop may have a first end adjacent to the rotation lever 1125 and a second end away from the rotation lever 1125. A distance between the first end and the rotation shaft 1126 may be longer than a distance between the second end and the rotation shaft 1126.

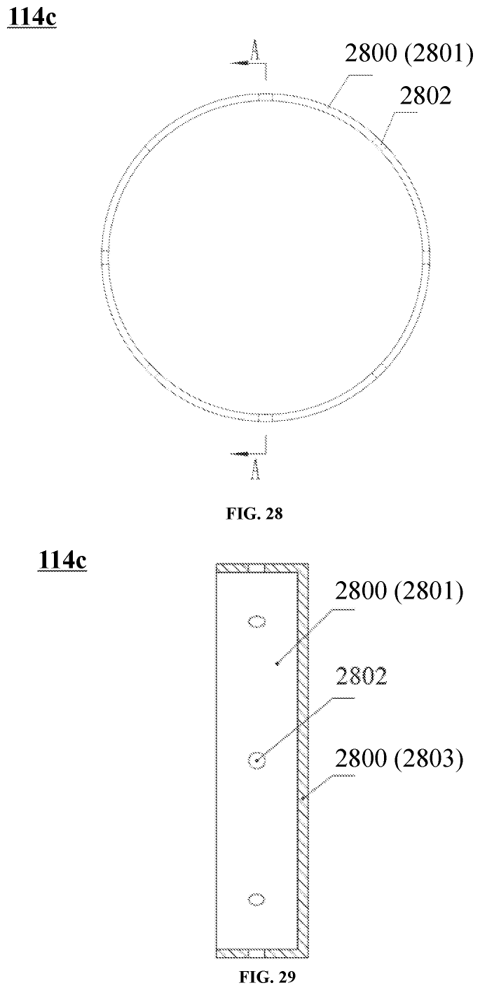

FIG. 28 illustrates a front view of an exemplary locking member 114c according to some embodiments of the present disclosure. FIG. 29 illustrates a sectional view of the locking member 114c according to some embodiments of the present disclosure.

The locking member 114c may be mounted on or integrated into a vehicle (not shown in FIGS. 28 to 30) to be locked. The vehicle may include a frame, a wheel, a rotation shaft, a plurality of spokes, or the like, or any combination thereof. In some embodiments, the locking member 114c may be mounted on the frame, the wheel, or the rotation shaft of the vehicle. For example, the locking member 114c may be fixedly mounted on the wheel by welding, a riveting, or the like. As another example, the locking member 114c may be detachably mounted on the wheel by a bolt connection, a threaded connection, a screw connection, or the like. Optionally, the locking member 114c may rotate with the rotation of the wheel.

As shown in FIGS. 28 to 29, the locking member 114c may have a ring structure formed by, for example, bending a plate. The locking member 114c may include a ring body 2800 and one or more locking holes 2802. The ring body 2800 may include a locking ring 2801 and a connection base 2803. The locking hole(s) 2802 may be located on the locking ring 2801. A lock pin (e.g., the lock pin 203, the lock pin 1106) of a lock body (e.g., the lock body 112) may be inserted into the locking hole(s) 2802 to lock the vehicle. An axis of the ring body 2800 may be parallel to an axis of the wheel. Optionally, the locking hole(s) 2802 may include a plurality of locking holes 2802 that are arranged uniformly or non-uniformly around the axis of the ring body 2800. As used herein, an axis of a circular structure (e.g., a ring, a hole) may refer to a rotation axis around which the circular structure may rotate.

As shown in FIGS. 28 and 29, an axis of the locking hole(s) 2802 may be parallel to a radial direction of the ring body 2800 (i.e., a direction along a diameter of the ring body 2800). The lock pin may be inserted into the locking hole(s) 2802 along the radial direction of the ring body 2800. The lock pin and the locking member 114c may be mounted on any suitable positions so that the lock pin may be inserted into the locking hole(s) 2802 along the radial direction of the ring body 2800. For example, the locking member 114c may be mounted on an inner circumference of a wheel rim or an outer circumference of spokes of the vehicle. As another example, the locking member 114c may be mounted on a rotation shaft of the wheel, and the corresponding lock body may be mounted on the frame and located on an outside circumference of the ring body 2800.

The locking hole(s) 2802 may include through hole(s), which may enable a more stable connection between the lock pin and the locking hole(s) 2802 when the lock pin is inserted into the locking hole(s) 2802. In some alternative embodiments, the depth of the locking hole(s) 2802 may be smaller than the thickness of the ring body 2800, such as half of the thickness of the ring body 2800. In some embodiments, the locking hole(s) 2802 may include a straight hole that has a uniform diameter at different positions, a tapered hole that has different diameters at different positions (e.g., at the two ends of the tapered hole), or the like.

In some embodiments, the locking hole(s) 2802 may be straight hole(s). Each locking hole 2802 may include a chamfer located at a side of the locking hole 2802 facing the lock pin, which may allow convenience for the lock pin to insert into the locking hole 2802. Merely by way of example, the chamfer may include a circular chamfer, a 45° x45° chamfer, a 30° x60° chamfer, or the like. In some embodiments, the locking hole(s) 2802 may have an opening at the side surface of the locking hole(s) 2802. The locking hole(s) 2802 and the corresponding opening may form a locking groove, so that the machining of the locking hole 2802 may be easier.

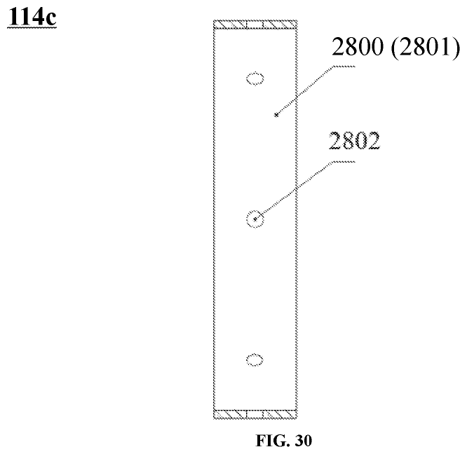

In some embodiments, the connection base 2803 may be configured to mount the locking member 114c on the vehicle to be locked. For example, the connection base 2803 may be fixedly mounted the frame, the rotation shaft, or an end of a spoke of the vehicle. The locking ring 2801 may be mounted on one side of the connection base 2803 away from the wheel. For example, the connection base 2803 may be fixedly mounted on the locking ring 2801 by welding, a riveting, or the like. As another example, the connection base 2803 may be detachably mounted on the locking ring 2801 by a bolt connection, a threaded connection, a screw connection, or the like. As yet another example, the connection base 2803 and the locking ring 2801 may form an integral part. The connection base 2803 may be configured as a circular plate, a square plate, an annular plate, or the like. Merely by way of example, the connection base 2803 may be a circular plate, and a diameter of the connection base 2803 may be the same as an outer diameter of the locking ring 2801. In some embodiments, the connection base 2803 may be omitted as shown in FIG. 30.

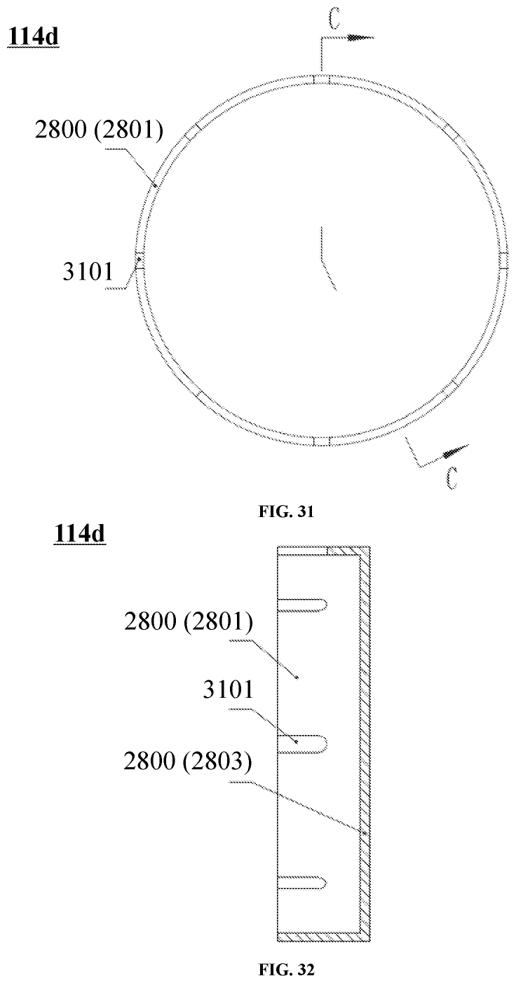

FIG. 31 illustrates a front view of an exemplary locking member 114d according to some embodiments of the present disclosure. FIG. 32 illustrates a sectional view of the locking member 114d according to some embodiments of the present disclosure. The locking member 114d may be similar to the locking member 114c as described in connection with FIGS. 28-30, except that the locking member 114d may include one or more locking holes 3101 that are different from the locking hole(s) 2802 of the locking member 114c. As shown in FIGS. 31 and 32, each locking hole 3102 may have an opening at the side surface of the locking hole 3101. Each locking hole 3101 and its corresponding opening may form a locking groove to match a lock pin.

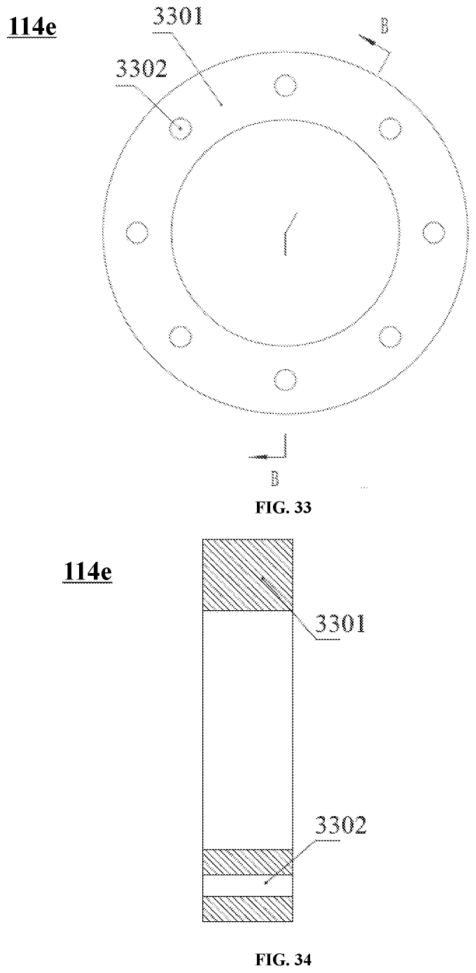

FIG. 33 illustrates a front view of an exemplary locking member 114e according to some embodiments of the present disclosure. FIG. 34 illustrates a sectional view of the locking member 114e according to some embodiments of the present disclosure. The locking member 114e may be integrated into or mounted on a vehicle (not shown in FIGS. 33 and 34) to be locked. For example, the locking member 114e may be mounted on the vehicle 200 in a similar manner as the locking member 114c as described in connection with FIGS. 28 and 29.

As shown in FIGS. 33 and 34, the locking member 114e may include a ring structure formed by arranging a through hole in the middle of a disc. The locking member 114e may include a locking ring 3301 (as a ring body of the locking member 114e) and one or more locking holes 3302 located on the locking ring 3301. A lock pin (e.g., the lock pin 203, the lock pin 1106) of a lock body (e.g., the lock body 112) may be inserted into the locking hole(s) 3302 to lock the vehicle. An axis of the locking ring 3301 may be parallel to an axis of a wheel of the vehicle. In some embodiments, the locking hole(s) 3302 may include a plurality of locking holes 3302 that are arranged uniformly or non-uniformly around the axis of the locking ring 3301. The locking hole(s) 3302 may include a through hole, a straight hole, a tapered hole, or the like. Optionally, each locking hole 3302 may include a chamfer as described elsewhere in this disclosure (e.g., FIGS. 28 and 29 and the relevant descriptions).

An axis of the locking hole(s) 3302 may be parallel to the axis of the locking ring 3301 (or the ring body), and the lock pin of the lock body may be inserted into the locking hole(s) 3302 along an axial direction of the locking ring 3301 (or the ring body). The lock body and the locking member 114e may be mounted on any suitable positions so that the lock pin may be inserted into the locking hole(s) 3302 along the axial direction of the locking ring 3301. Merely by way of example, the locking member 114e and the lock body may be mounted on the vehicle in a similar manner as the locking member 114a and the lock body 112a as shown in FIG. 2, that is, the locking member 114e may be mounted on the left or right side of the wheel of the vehicle and the lock body may be spaced apart from the front surface of the locking ring 3301 by a distance (e.g., mounted on the rotation shaft of the wheel). In some embodiments, the locking ring 3301 may be rotatably connected to the rotation shaft and fixedly connected to the wheel, and the lock body may be fixedly connected to the rotation shaft. In such cases, the lock body may not affect the rotation of the locking member 114e with the wheel.

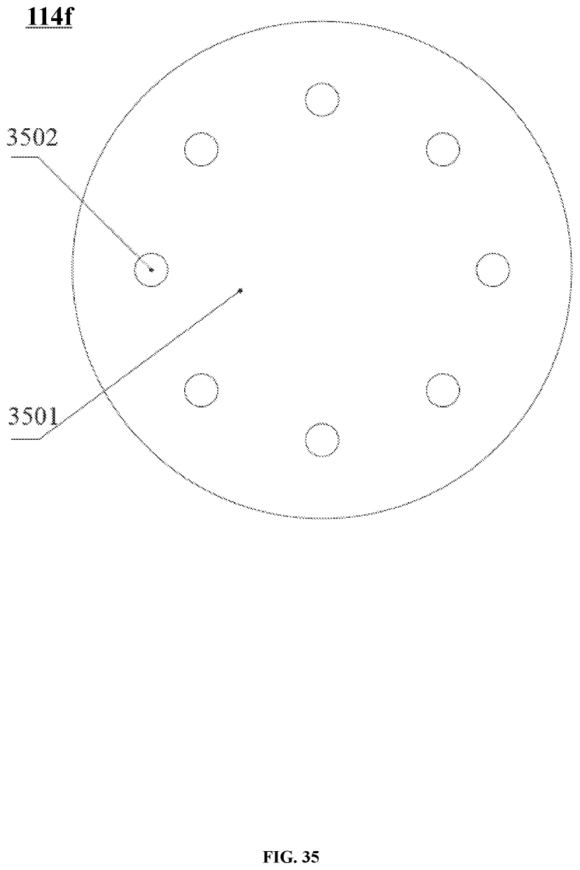

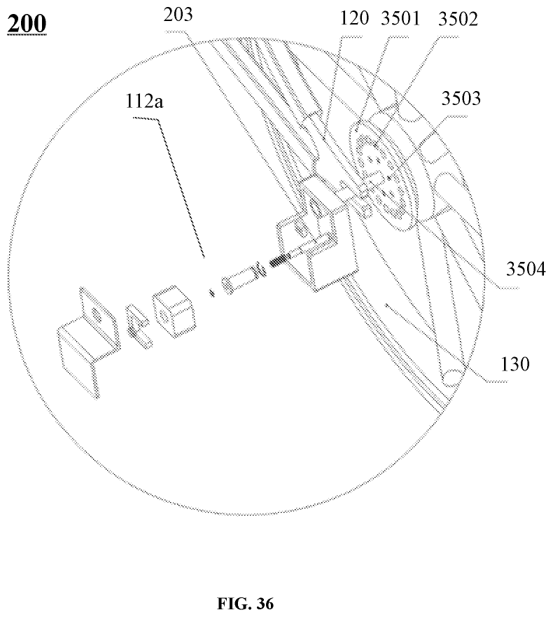

FIG. 35 illustrates a front view of an exemplary locking member 114f according to some embodiments of the present disclosure. FIG. 36 illustrates a partial enlarged view of a portion of an exemplary vehicle 200 on which the locking member 114f is mounted according to some embodiments of the present disclosure. The locking member 114f may be mounted on a wheel 130 of the vehicle 200 through a fixed connection or a detachable connection.

As shown in FIG. 35, the locking member 114f may include a disc body 3501 and one or more locking holes 3502 located on the disc body 3501. An axis of the disc body 3501 may be parallel to an axis of the wheel 130 of the vehicle 200. The locking hole(s) 3502 may have a same or similar configuration as the locking hole(s) 3302 as described in connection with FIGS. 33 and 34. As shown in FIG. 36, an axis of the locking hole(s) 3502 may be parallel to the axis of the disc body 3501, and a lock pin 203 of a lock body 112a may be inserted into the locking hole(s) 3502 along an axial direction of the disc body 3501. Such configuration of the locking hole(s) 3502 may have less influence on the strength of the locking member 114f and increase the service life of the locking member 114f.

In some embodiments, the disc body 3501 and the corresponding locking body 112a may be mounted on the wheel 130 of the vehicle 200 as shown in FIG. 36. The locking body 112a may be spaced apart from a front surface of the disc body 3501 by a distance. For example, the disc body 3501 may be mounted on one end of a shaft hole of an inner ring of the wheel hub of the wheel 130. The disc body 3501 may have a small area and easy install, and the disc body 3501 may have high stability after being mounted. Optionally, the disc body 3501 may include a mounting hole coaxial with the disc body 3501. The disc body 3501 may be mounted on the wheel 130 by a mounting mechanism (e.g., a bolt, a pin, and/or a screw) passing through the mounting hole. Additionally or alternatively, the disc body 3501 may include a connection shaft 3504 coaxial with the disc body 3501. The connection shaft 3504 may establish a rotatable connection between the disc body 3501 and the vehicle 200 (e.g., the frame 120 or a rotation shaft of the vehicle). In some embodiments, the connection shaft 3504 may include a connection hole (e.g., a straight hole) coaxial with the connection shaft 3504 used to mount the disc body 3501 on the vehicle 200.

It should be noted that the descriptions regarding FIGS. 28 to 36 are merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, a locking member (e.g., anyone of the locking member 114c to 114f) may include one or more additional components and/or one or more components of the locking member described above may be omitted. For example, the locking member may further include a wheel sensor configured to detect a rotational state of the wheel. Additionally or alternatively, two or more components of the locking member may be integrated into a single component. A component of the locking member may be implemented on two or more sub-components. In addition, the shape, size, position of a component shown in FIGS. 28 to 36 are illustrative and not intended to be limiting.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1-80. (canceled)

81. A lock for locking a vehicle with a wheel comprising spokes, the lock comprising
a lock body comprising a lock pin; and
a locking member comprising at least one locking hole,
wherein the vehicle is locked by inserting the lock pin into the at least one locking hole without crossing any of the spokes from a first side to a second side of the wheel.

82. The lock of claim 81, wherein the vehicle further comprises a frame, and wherein one of the lock body or the locking member is mounted on the frame, and the other one of the lock body or the locking member is mounted on the wheel, rotating with the wheel.

83. The lock of claim 81, wherein the locking member comprises a ring body, an axis of the ring body is parallel to an axis of the wheel, and the at least one locking hole is located on the ring body.

84. The lock of claim 83, wherein:
an axis of the at least one locking hole is parallel to an axial direction of the ring body, and the lock pin is inserted into the at least one locking hole along the axial direction of the ring body, or
the axis of the at least one locking hole is parallel with a radial direction of the ring body, and the lock pin is inserted into the at least one locking hole along the radial direction of the ring body.

85. The lock of claim 81, wherein:
the locking member comprises a disc body,
an axis of the disc body is parallel to an axis of the wheel, and
the at least one locking hole is located on the disc body.

86. The lock of claim 85, wherein:
an axis of the at least one locking hole is parallel to an axial direction of the disc body, and
the lock pin is inserted into the at least one locking hole along the axial direction of the disc body.

87. The lock of claim 81, wherein the lock body further comprises:
a transmission mechanism mechanically connected to the lock pin; and
a driving member mechanically connected to the transmission mechanism, wherein the driving member is configured to drive a movement of the lock pin via the transmission mechanism.

88. The lock of claim 87, wherein the transmission mechanism comprises:
a transmission wheel, a first side of the transmission wheel being mechanically connected to the driving member;
a first linkage member mechanically connected to the lock pin; and
a protrusion abutting against at least a portion of the first linkage member and mounted on a second side of the transmission wheel, wherein
the second side of the transmission wheel is opposite to the first side of the transmission wheel, and
driven by the driving member, the protrusion is configured to retract the lock pin from the at least one locking hole.

89. The lock of claim 88, wherein the lock further comprises a mechanical locking mechanism configured to lock the first linkage member after the lock pin is retracted, and wherein
the mechanical locking mechanism comprises a rotation lever, a locking block, and a rotation shaft,
the locking block is located at an end of the rotation lever, and
the rotation lever is mechanically connected to the rotation shaft and configured to rotate around the rotation shaft to drive the locking block to abut against the first linkage member.

90. The lock of claim 89, wherein the mechanical locking mechanism further comprises an elastic device mechanically connected to the rotation lever and configured to drive the locking block to rotate toward the first linkage member.

91. The lock of claim 90, wherein the elastic device comprises at least one of a compression spring, a tension spring, or a torsion spring.

92. The lock of claim 88, wherein the transmission mechanism comprises:
a second linkage member fixed with the lock pin; and
a transmission cam mounted on the driving member, a sidewall of the transmission cam abutting against at least a portion of the second linkage member, and wherein driven by the driving member, the transmission cam is configured to retract the lock pin from the at least one locking hole.

93. The lock of claim 81, wherein the lock body further comprises:
an electromagnet comprising a sliding hole; and
a magnetic core slidably mounted within the sliding hole and mechanically connected to the lock pin, wherein under the action of the electromagnet, the magnetic core is configured to drive the lock pin to slide along the sliding hole.

94. The lock of claim 93, wherein the magnetic core comprises a through hole, and the lock pin is inserted into the through hole

95. The lock of claim 94, wherein:
the through hole is a threaded hole, and
an end of the lock pin has an external thread matching the threaded hole.

96. The lock of claim 94, wherein:
the through hole is a straight hole,
the lock pin comprises a first slot, and
a first circlip is mounted in the first slot for preventing the lock pin from sliding out from the through hole.

97. The lock of claim 93, wherein:
a first end of the magnetic core comprises a stopping member,
an outer wall of a second end of the magnetic core comprises a second slot, and
a second circlip is mounted in the second slot for preventing the magnetic core from sliding out from the electromagnet.

98. The lock of claim 81, further comprising a reset device mounted on the lock pin configured to retract the lock pin from the at least one locking hole or insert the lock pin into the at least one locking hole.

99. The lock of claim 81, further comprising a detection switch configured to detect a position of the lock pin.

100. The lock of claim 81, wherein the vehicle further comprises a wheel sensor configured to detect a rotational state of the wheel.
